(19) United States
(12) Patent Application Publication
(10) Pub. No.: US 2011/0004849 A1
(43) Pub. Date: Jan. 6, 2011

(54) INPUTTING METHOD BY PREDICTING A WORD AND ELECTRONIC DEVICE FOR PRACTICING THE METHOD

(76) Inventor: Eui Jin Oh, Daejeon (KR)

Correspondence Address: LEXYOUME IP GROUP, PLLC, 5180 PARKSTONE DRIVE, SUITE 175, CHANTILLY, VA, 20151, US

(21) Appl. No.: 12/865,730

(22) PCT Filed: Feb. 2, 2009
(86) PCT No.: PCT/KR09/00512

§ 371 Date: Aug. 2, 2010

(30) Foreign Application Priority Data
Feb. 1, 2008 (KR) 10-2008-0010461
Feb. 1, 2008 (KR) 10-2008-0010465
Mar. 6, 2008 (KR) 10-2008-0021174
May 29, 2008 (KR) 10-2008-0050259

(51) Int. Cl. G06F 3/048

(52) U.S. Cl. 715/816

(57) ABSTRACT

The present invention relates to a method of predicting and entering a word and an electronic device in which the method is implemented. The method of predicting and entering a word includes the steps of entering a premise letter through one or more direction inputs from among a contact, pressing, movement, and an inclination for indication locations radially arranged around a reference location and spaced apart from one another; switching to a prediction word entry mode in response to a set input and arranging prediction words, including the premise letter, in the indication locations; and selecting an intended word from among the prediction words through the direction input and entering the selected word.

### TECHNICAL FIELD

The present invention relates to a method of predicting and entering a word and an electronic device in which the method is implemented, and more particularly, to a method of predicting and entering a word, in which when first 3 letters corresponding to an intended word are entered, a prediction word group including the letters is generated and an intended word is selected from the prediction word group easily and fast and an electronic device in which the method is implemented.

### BACKGROUND ART

Lots of researches have been done to reduce a user's efforts to perform key entry in which all letters assigned to respective keys must be entered when the user enters a letter through the key entry and to improve the convenience of entry.

As a result of the researches, there is a method of, when a user enters some letters of a word at the beginning, predicting the remaining letters. This method requires the user to enter basic letters forming the front part of the word that the user actually wants to enter. In other words, for example, if a user is sought to enter an English word ‘communication’, the user must enter all letters in order of the letters arranged until the ‘communication’ is selected from a prediction word group. Furthermore, the user must enter at least ‘communic’ because there are many words, such as ‘communicate’, which are similar to the word ‘communication’. Accordingly, if a word is long, a user must inconveniently perform a lot of key entry in order to enter one word.

Further, in a conventional method, all letters corresponding to a word to be entered must be correctly entered until the word is selected. For example, in the case in which a user wants to enter the ‘communication’, but does not fully remember the consonants and the vowels of the ‘communication’ (e.g., in the case in which the user does not clearly know whether ‘u’ or ‘e’ follows ‘comm’), the user feels difficult to enter the ‘communication’, and there is a problem in that a task of entering the entire word is delay because one vowel is not known to the user.

In addition, in a conventional method, in order to select an intended word from a prediction word group, a cursor or an active block must be moved to a column where the corresponding word is placed using a direction key (▾ or ▴). For example, in the case in which up to ‘communic’ is entered in order to enter the word ‘communication’, in a conventional method, a group of prediction words including the ‘communic’ are arranged in series. In order to select the word ‘communication’ from the prediction word group, the direction key (▾ or ▴) must be pressed plural times so that it is moved to a column where the word ‘communication’ is placed in the prediction word group.

Accordingly, since the direction key is pressed plural times, the number of entries is increased. Further, the time that it takes to enter a word is increased because the direction key is a function key not frequently used in a common document task. In addition, a user's fatigue is increased because of the plurality of consecutive key entries. For this reason, a user rarely uses the conventional method in order to consecutively enter a plurality of words.

### DISCLOSURE

### Technical Problem

Accordingly, the present invention has been made in view of the above problems, and it is an object of the present invention to provide a method of predicting and entering a word in which when only some letters of a word are entered, an intended word can be selected and an electronic device in which the method is implemented.

It is another object of the present invention to provide a method of predicting and entering a word in which even though a user does not correctly remember all letters forming a word, the corresponding word can be entered and an electronic device in which the method is implemented.

It is yet another object of the present invention to provide a letter entry device capable of selecting a prediction word in accordance with a simple procedure or completing a sentence while automatically entering the prediction word and a method of predicting and entering letters through the letter entry device.

It is further yet another object of the present invention to provide a letter entry device which can be used in a computer, a mobile phone, and a PDA and a method of predicting and entering letters through the letter entry device.

It is further yet another object of the present invention to provide a letter entry device capable of completing a sentence through only the movement of a finger on a touch screen using a touch screen method and a method of predicting and entering letters through the letter entry device.

### Technical Solution

To achieve the above objects, according to an aspect of the present invention, there is provided a method of predicting and entering a word, comprising the steps of entering a premise letter through one or more direction inputs from among a contact, pressing, movement, and an inclination for indication locations radially arranged around a reference location and spaced apart from one another; switching to a prediction word entry mode in response to a set input and arranging prediction words, including the premise letter, in the indication locations; and selecting an intended word from among the prediction words through the direction input and entering the selected word.

In this case, the premise letter comprises first 3 or less letters of the intended word.

Further, the direction inputs according to the contact, the pressing, the movement, and the inclination are assigned different letters.

Further, in the prediction word selection step, the prediction words are selected through a combination of two or more input operations of the direction inputs.

Alternatively, the prediction word selection step comprises the step of rearranging the derivative words of a prediction word selected by performing any one of the direction inputs.

Meanwhile, the switch of the prediction word entry mode is performed by a center input for the reference location or an input using an additional key.

Further, the switch of the prediction word entry mode is performed by consecutively performing two or more input operations of the direction inputs, including the direction inputs for the entry of the premise letter.

Further, the switch of the prediction word entry mode is performed by any one of the direction inputs.

Further, the indication locations comprise a plurality of first indication locations radially arranged around the reference location and spaced apart from one another and a plurality of second indication locations radially arranged around each of the first indication locations and spaced apart from one another. Here, different letters are assigned to respective direction inputs for the first indication locations and the second indication locations.

### ADVANTAGEOUS EFFECTS

The method of predicting and entering a word and an electronic device in which the method is implemented according to the present invention are advantageous in that an intended word can be entered easily and fast because the intended word can be selected if only some letters of the word are entered.

Further, according to the present invention, even though a user does not correctly remember individual letters forming a word, the corresponding word can be entered. Accordingly, there are advantages in that a user's efforts to find correct letters forming a word while entering the word can be reduced and user convenience can be improved.

Further, according to the present invention, although a user uses function keys while less using function keys other than letter enter keys that are frequently used at normal times, the user can enter a letter string using function keys that are relatively frequently used, such as the space bar, the enter key, and the shift key, when inputting a common document. Accordingly, there are advantages in that a user's fatigue and inconvenience resulting from the use of less experienced function keys can be solved and the speed of entry of a letter string can be increased.

In addition, according to the present invention, while a prediction word is selected in accordance with a simple procedure or automatically entered, a sentence can be completed. Accordingly, there are advantages in that the number of entries can be reduced by a simple operation and a desired word or sentence can be correctly entered.

Moreover, according to the present invention, in a letter entry device and a method of predicting and entering letters through the letter entry device, a computer, a mobile phone, and a PDA which are commonly used can be used as a letter entry device. Accordingly, there is an advantage in that the present invention can be conveniently implemented by mounting it on the existing letter entry device even without an additional letter entry device.

Furthermore, according to the present invention, a sentence can be completed through the movement of a finger on a touch screen using a touch screen method. Accordingly, there are advantages in that any one can easily enter a sentence because a user interface can be improved and a user's fatigue resulting from a task of entering a sentence can be significantly reduced.

### DESCRIPTION OF DRAWINGS

FIG. 1 is a conceptual diagram showing a letter entry device for implementing a method of predicting and entering a word according to the present invention;

FIGS. 2 to 12 are configuration diagrams showing the letter entry device for implementing the method of predicting and entering a word according to the present invention;

FIG. 13 is a conceptual diagram showing a letter entry device for implementing a method of predicting and entering a word according to the present invention;

FIGS. 14 and 15 are configuration diagrams showing a letter entry device for implementing a method of predicting and entering a word according to the present invention;

FIGS. 16 and 17 are diagrams illustrating the input used in the method of predicting and entering a word according to the present invention;

FIGS. 18 to 20 are conceptual diagrams showing detailed examples of the method of predicting and entering a word according to the present invention;

FIG. 21 is a flowchart illustrating the method of predicting and entering a word according to the present invention;

FIGS. 22 and 23 are conceptual diagrams showing another example of the method of predicting and entering a word according to the present invention;

FIG. 24 is a state diagram showing an example of a center direction input according to the present invention;

FIGS. 25 to 27 are state diagrams illustrating examples of a method of predicting and entering letters according to the present invention;

FIG. 28 is a flowchart illustrating another example of the method of predicting and entering letters according to the present invention;

FIGS. 29 to 31 are state diagrams showing paradigms of the method of predicting and entering letters shown in FIG. 28;

FIG. 32 is a flowchart illustrating yet another example of the method of predicting and entering letters according to the present invention;

FIGS. 33 to 35 are state diagrams showing paradigms of the method of predicting and entering letters shown in FIG. 32;

FIG. 36 is a flowchart illustrating an embodiment of a method of predicting and entering letters through a letter entry device according to the present invention;

FIG. 37 is a configuration diagram showing embodiments according to the present invention;

FIG. 38 is a front view of a computer for implementing the method of predicting and entering letters through a letter entry device according to the present invention;

FIG. 39 is a front view of a mobile phone for implementing the method of predicting and entering letters through a letter entry device according to the present invention;

FIG. 40 is a front view of a PDA for implementing the method of predicting and entering letters through a letter entry device according to the present invention;

FIG. 41 is a flowchart illustrating another embodiment of the method of predicting and entering letters through a letter entry device according to the present invention;

FIG. 42 is a configuration diagram illustrating another embodiment according to the present invention;

FIG. 43 is a flowchart illustrating yet another embodiment of the method of predicting and entering letters through a letter entry device according to the present invention;

FIG. 44 is a flowchart illustrating a modified example of the embodiment described with reference to FIG. 43;

FIG. 45 is a flowchart illustrating another modified example of the embodiment described with reference to FIG. 43;

FIG. 46 is a flowchart illustrating yet another embodiment according to the present invention;

FIGS. 47 to 53 are configuration diagrams illustrating the embodiment described with reference to FIG. 46;

FIG. 54 is a flowchart illustrating a modified example of the embodiment described with reference to FIG. 46;

FIGS. 55 to 57 are configuration diagrams illustrating the modified example described with reference to FIG. 54;

FIG. 58 is a flowchart illustrating another modified example of the embodiment described with reference to FIG. 46;

FIG. 59 is a configuration diagram illustrating the modified example described with reference to FIG. 58; and

FIG. 60 is an exemplary diagram of a letter entry method through the activation of a prediction word.

### MODE FOR INVENTION

Hereinafter, a method of predicting and entering a word and an electronic device in which the method is implemented according to the present invention are described below with reference to the accompanying drawings.

In a conventional prediction suggestion for premise letters, several letters are shown only once. However, in a direction prediction suggestion according to the direction input of the present invention, prediction letters of a first step are displayed in response to any one direction input in relation to specific premise letters. When any one of the prediction letters of the first step is selected, words related to the prediction letter selected in the first step or prediction letters of an advanced second step are further displayed in response to another direction input. When any one of the prediction letters suggested in the second step is selected, prediction letters of a third step related to the prediction letter selected in the second step are further displayed in response to yet another direction input. Accordingly, a possibility that a desired prediction letter can be selected can be increased because a prediction letter can be further expanded.

Further, in the present invention, the prediction letters suggested in the first step can be a derivative word, an original word, or a-part-of-speech classification category which is related to one or more premise letters so that a user can find a desired word more effectively.

Meanwhile, in the present invention, the direction input can be any one of direction movement, direction pressing, a direction inclination, a direction contact movement, a direction horizontal pressing, a direction vertical pressing, and a direction inclination pressing which are implemented on a direction input device or a touch screen.

Although any one direction input is described as an example in the present invention, a direction input in each embodiment is not limited to the above-described direction inputs and can be any one of the direction inputs.

Further, in the present invention, the prediction letter can be activated or selected through a center input, a direction input, or an additional enter key.

In addition, a direction prediction input in the present invention can be implemented through various directional letter entry devices.

Moreover, each of embodiments to be described below can be implemented not only in a letter entry device, but also on a touch screen.

In the present invention, a prediction letter can be selected by performing a selection movement key or a numeric key several times as in the existing prediction input method in order to select suggested prediction letters, or a desired prediction letter for all suggested prediction letters can be immediately selected only once without using a mouse pointer. Accordingly, a prediction letter can be selected very fast.

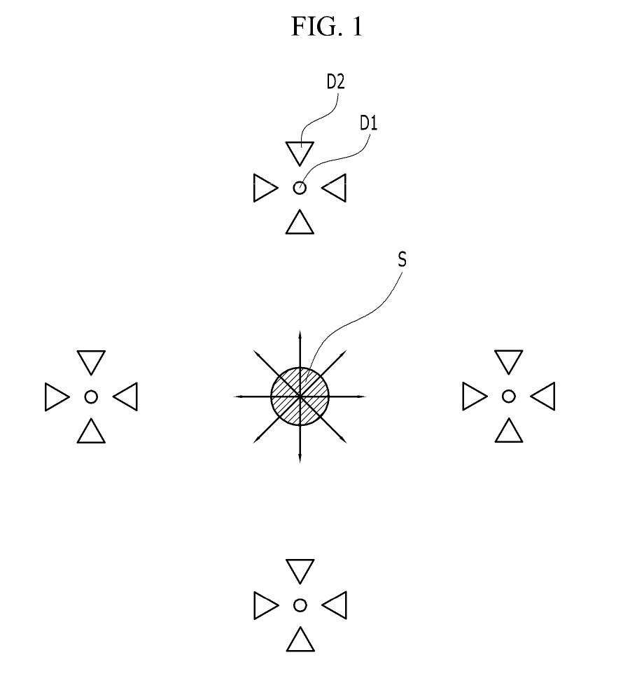

Meanwhile, a method of predicting and entering a word according to the present invention is implemented in an input unit 10 configured to include a reference location S, a plurality of first indication locations D1 radially arranged around the reference location S and spaced apart from one another, and a plurality of second indication locations D2 radially arranged around the first indication locations D1 and spaced apart from one another and to enter data assigned to the reference location S, the first indication locations D1, and the second indication locations D2 in accordance with a contact, pressing, direction movement or an inclination for the reference location S, the first indication locations D1, and the second indication locations D2 or to execute a specific command. The reference location S, the first indication locations D1, and the second indication locations D2 of the input unit 10 can be arranged as shown in FIG. 1.

It is preferred that the assigned data be displayed in response to the reference location S, the first indication locations D1, and the second indication locations D2 in a display window 30 connected to the input unit 10.

Further, a control unit (not shown) for processing an input for the input unit 10 and a memory unit (not shown) for storing data corresponding to the input are electrically connected between the input unit 10 and the display window 30.

A letter entry device, including the input unit 10, the display window 30, the control unit, and the memory unit, can be implemented in accordance with various embodiments. In particular, the present invention can be implemented in various letter entry devices which were invented and filed by the inventor of the present invention.

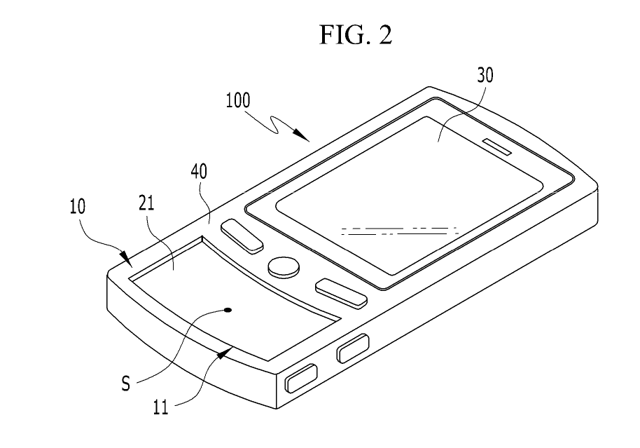

That is, as shown in FIG. 2, the input unit 10 can include a detection unit 21 provided on an entry area 11. The detection unit 21 can detect a contact or the movement of a contact and thus can detect a center input according to a contact for the reference location S, such as that shown in FIG. 1, or the movement of the contact, the first direction input according to a contact for the first indication location D1 or the movement of the contact, and a second direction input according to a contact for the second indication location D2 or the movement of the contact.

Here, data are assigned to the center input, the first direction input, and the second direction input, respectively, and thus the data assigned to the respective inputs are processed in response to the respective inputs.

The detection unit 21 can be provided in various kinds. For example, the detection unit 21 can be provided in the form of a touch pad as shown in FIG. 2 and can be provided in the form of a plurality of contact sensors, pressure sensors, pressing sensors (switches), or resistance sensors. Alternatively, the detection unit 21 can be provided in the form of a touch screen in which a display function is added to a touch pad.

Further, the detection unit 21 can be provided in the entire entry area 11, as shown in FIG. 2, or may be provided in specific areas corresponding to the reference location S, the first indication locations D1, and the second indication locations D2.

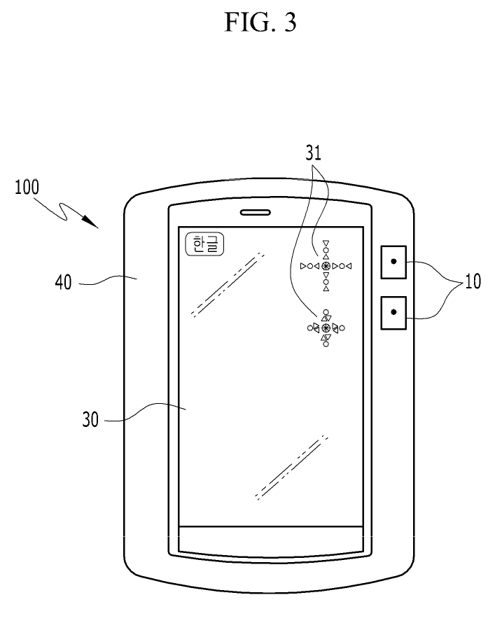

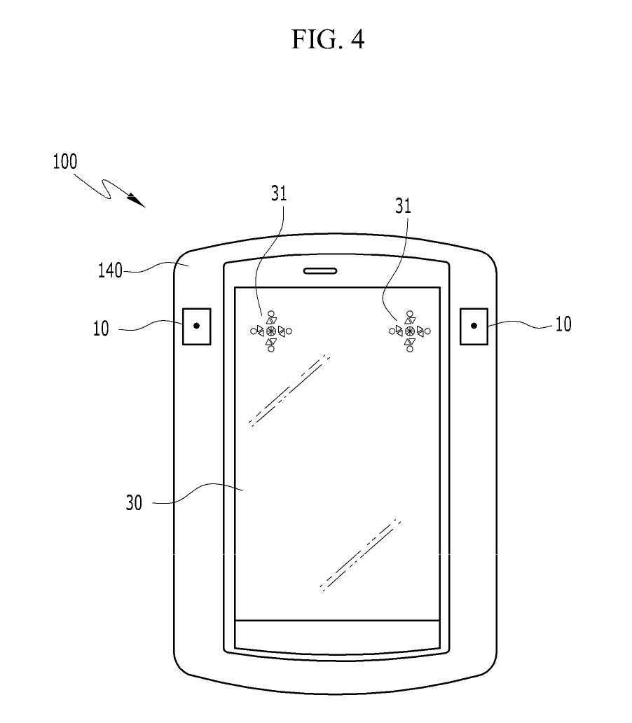

As described above, the detection unit 21 can be provided on one side of a base 40, whereas the display window 30 for displaying letters extracted by the control unit can be provided on the other side of the base 40. In this case, the display window 30 can be further provided with letter display units 31 (refer to FIGS. 3 and 4) for displaying letters, etc. which are assigned to respective input operations on the basis of the reference location S.

The letter display unit 31 displays input operations on the basis of the reference location S and letters assigned to the respective input operations so that a user can perform a letter entry while seeing the letter display unit 3. The letter display unit 31 can be configured to display or hide them according to a user's manipulation.

Further, the input unit 10 can include two reference locations S thus two sets of the inputs. Here, the two sets of inputs may be provided in the base 40 or on a touch pad or a touch screen, as shown in FIGS. 3 and 4.

Further, each of the two sets of inputs may be arranged up and down as shown in FIG. 3 or arranged left and right as shown in FIG. 4.

In the case in which as described above, the two sets of inputs are provided, the two sets of inputs may be configured to perform the same input operation or different input operations.

In the input unit 10, each of the letters of the letter display unit 31 can be entered by touching or touching and moving the detection unit 21 on the basis of the letter display unit 31. Here, the letters radially assigned to the first indication locations D1 around the reference location S and the letters assigned to the second indication locations D2 radially located in the first indication locations D1 can be arranged in the letter display unit 31.

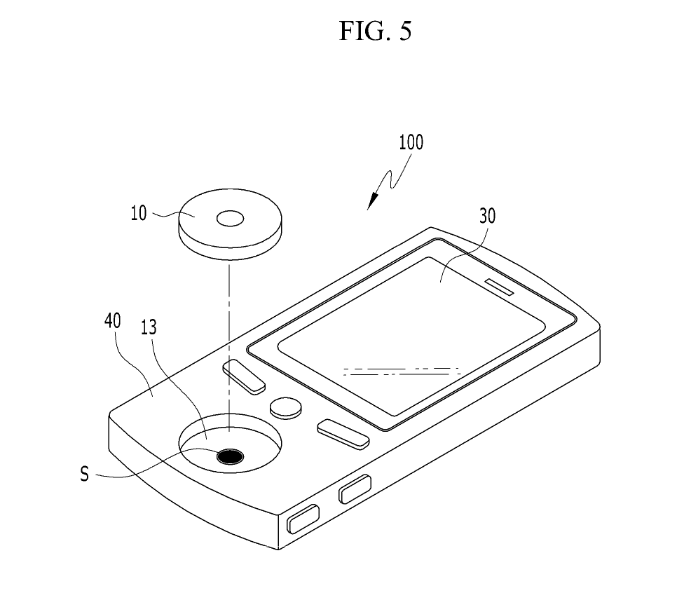

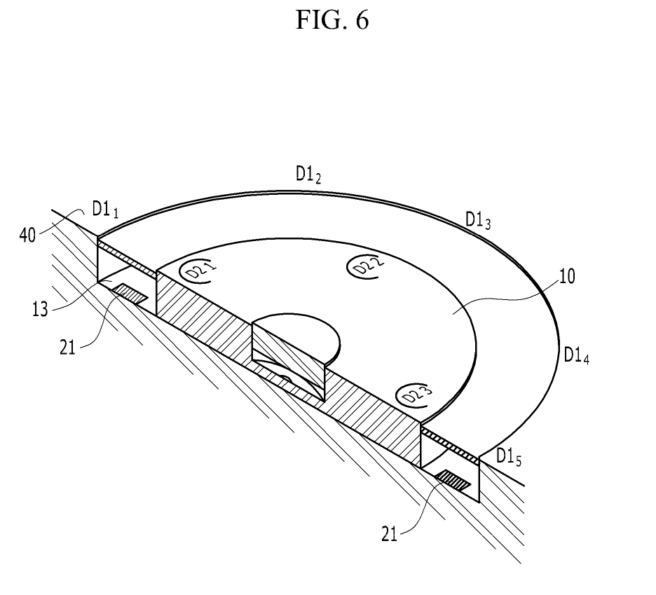

The letter entry device in which the present invention can be implemented may be configured as shown in FIGS. 5 and 6. Here, FIG. 5 is a cross-sectional view showing the coupling of the input unit 10 and the base 40 in the letter entry device shown in FIG. 4.

Referring to the drawing, the reference location S (refer to FIG. 4) is provided on one side of an input radius 13 provided in the base 40, and a plurality of first indication locations D1₁, D1₂, . . . , are radially arranged around the reference location S and spaced apart from one another.

Further, the detection unit 21 for detecting the horizontal movement of the input unit 10 is provided in the base 40 in response to each of the first indication locations D1₁, D1₂, . . . .

Accordingly, when the input unit 10 is moved from the reference location S to a specific first indication location D1₁, D1₂, . . . , the control unit extracts a first letter, assigned to the corresponding first indication location D1₁, D1₂, . . . , from the memory unit on the basis of a detection signal generated by the detection unit 21 which has detected the movement of the input unit 10 and enters the extract letter. That is, in the letter entry device of the present invention, the first direction input is performed by the movement of the input unit 10 for the first indication locations D1.

The detection unit 21 can be provided in various kinds. For example, the detection unit 21 may be provided in the form of pressure sensors, photosensors, or contact sensors, in the form of a touch pad or a touch screen provided in the entire input radius 13, or in a track pointer method.

Here, the first indication locations D1₁, D1₂, . . . can be provided in various numbers, if appropriate. For example, the number of first indication locations D1₁, D1₂, . . . , can be 8, as shown in FIG. 6, or may be 4 or 6.

Further, in the letter entry device, the second direction input is performed by selecting any one of a plurality of second indication locations D2₁, D2₂, . . . which are radially arranged and spaced apart from one another in the input unit 10. Second letters assigned to the corresponding second indication locations D2₁, D2₂, . . . , are selected by the second direction input.

Such a second direction input can be performed in various manners. For example, the second direction input can be performed as the input unit 10 is inclined toward any one of the second indication locations D2₁, D2₂, . . . . Alternatively, the second direction input may be performed by selecting any one of pressing units (not shown) provided in the input unit 10 in response to the second direction indication locations D2₁, D2₂, . . . , respectively.

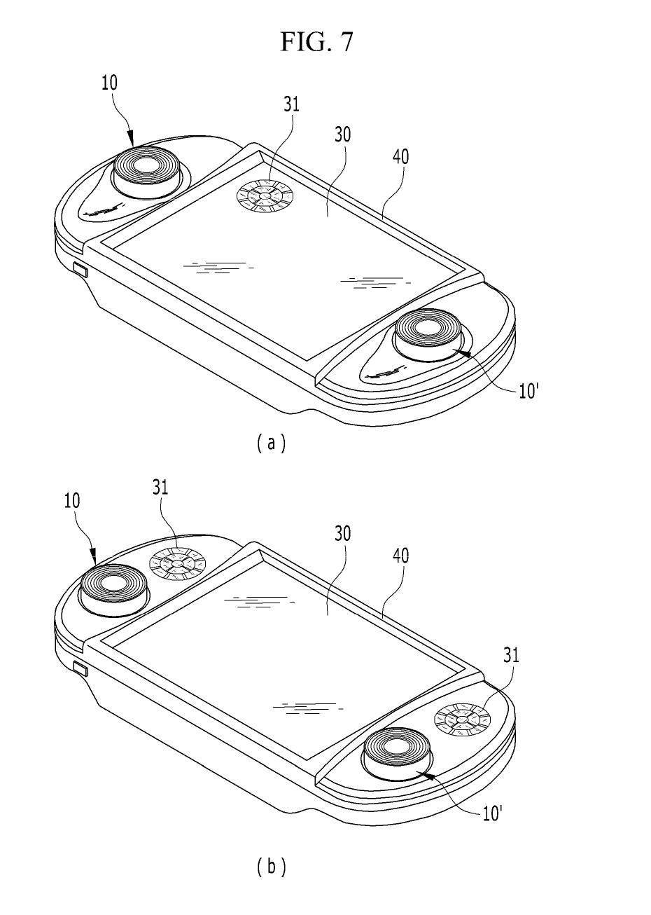

Further, the input units 10 may be provided on the left and right sides of the base 40 of a portable mobile communication terminal 100 as shown in FIG. 7.

In this case, the two input units 10 and 10′ may have the same configuration or difference configurations.

That is, the input unit 10 on the left side can be provided to enable the first direction input for the first indication locations D1, the second direction input for the second indication locations D2, and the center input for the reference location S. The input unit 10′ on the right side can be provided to enable a center combination input in which the center input and the direction input are combined or a direction combination input in which the first direction input and the second direction input are combined, in addition to the first direction input, the second direction input, and the center input.

Further, the number of indication locations may be different. Any one of the left and right inputs may be provided to enable a two-step input.

Further, a letter display unit 31 similar to that shown in FIGS. 3 and 4 can be provided in the display window 30 between the input units 10, as shown in FIG. 7(a). Further, the letter display unit 31, as shown in FIG. 7(b), may be provided on each of the input units 10 in the base 40 so that a user can easily recognize them.

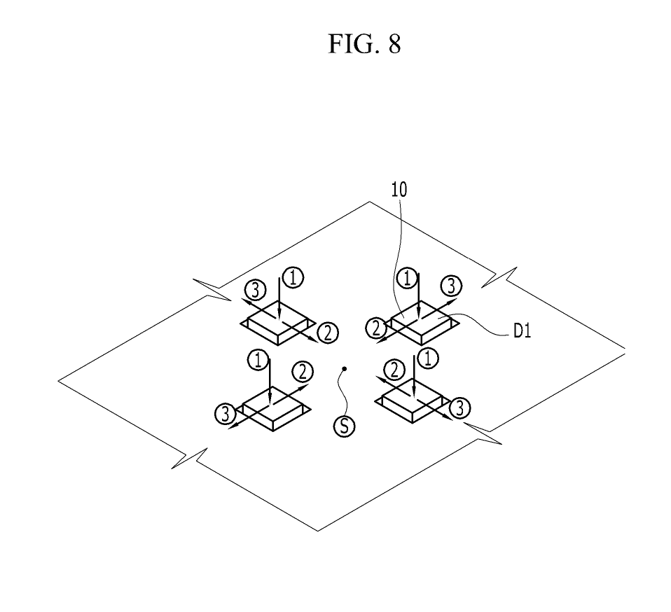

The letter entry device in which the present invention can be implemented may be configured as shown in FIG. 8.

As shown, the letter entry device can be formed in the form of input means 10 each having a sliding button form. The input means are installed in the first indication locations D1, respectively, which are radially arranged around the reference location S and spaced apart from one another.

In the input means 10, letters are entered by the direction inputs, including the pressing (\textcircled{1} of FIG. 8) of the input means 10, the movement (\textcircled{2} of FIG. 8) of the input means 10 in an inward direction toward the reference location S, the movement (\textcircled{3} of FIG. 8) of the input means 10 in an outward movement which is an opposite direction of the reference location S. Here, additional letters can be entered by the inward movement, the outward movement, and a right-angle direction (i.e., movement in a cylindrical direction).

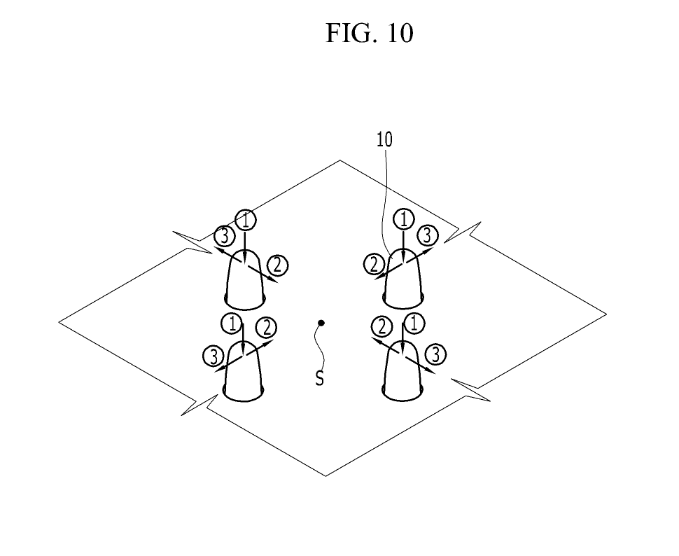

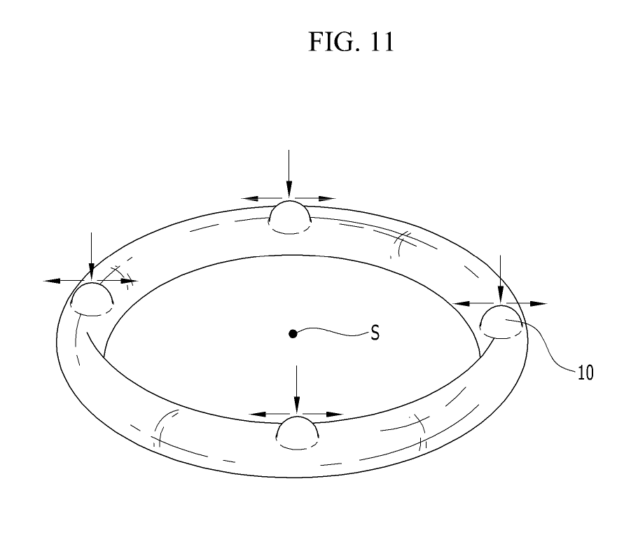

Further, the input means 10 may be provided in the form of a stick as shown in FIG. 10.

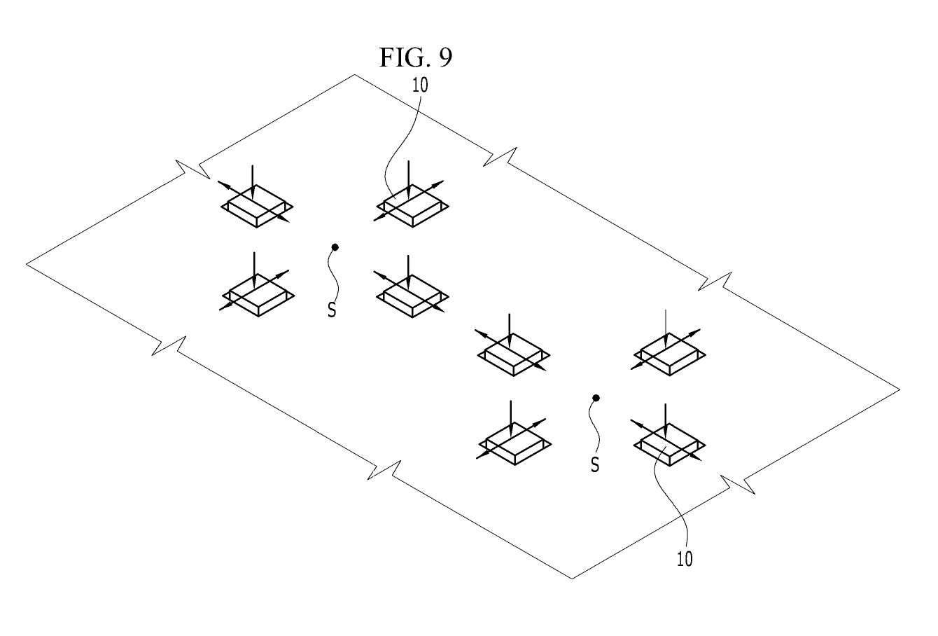

Further, as shown in FIG. 9, two pairs of the input means 10 shown in FIG. 8 may be configured.

Meanwhile, FIG. 10 shows a modified example of the letter entry device shown in FIG. 8. As in the present modified example, the input means 10 can be integrally provided in the form of a ring. Here, as in the input means 10 shown in FIG. 8, direction inputs according to pressing, an inward movement, and an outward movement are possible for the input means 10.

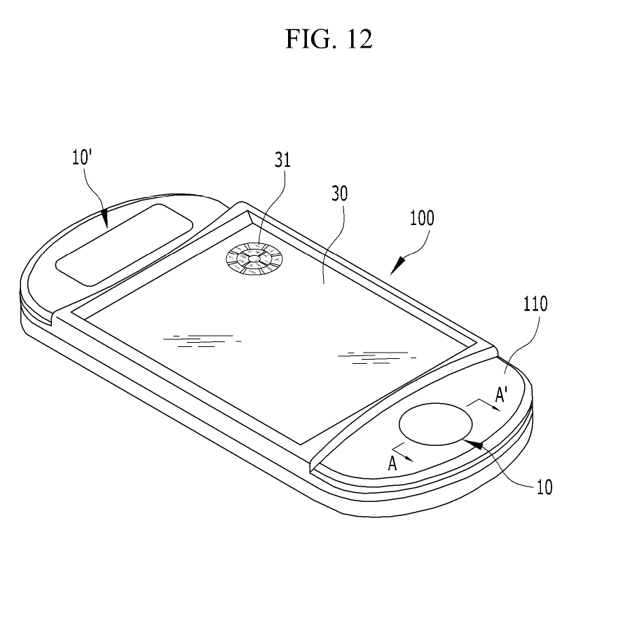

The letter entry device in which the present invention can be implemented may be configured as shown in FIGS. 12 to 14. The letter entry device is characterized in that it includes detection units 21 for detecting a vertical pressing and a horizontal pressing and enters data according to the vertical pressing and the horizontal pressing even without the substantial movement of a finger placed on the detection units 21.

More particularly, the letter entry devices 10, 10′ includes a detection unit provided to form a specific detection area on one side of the base 40 of a terminal 100 for an electronic device and a control unit.

The detection unit performs the first direction input by detecting a vertical pressing inclined in a specific first indication location D1 in the state in which a finger has been placed on the reference location S within the detection area and performs the second direction input by detecting a horizontal pressing for the second indication locations D2 out of the first indication location D1 of a finger placed on the reference location S.

Here, the term ‘vertical pressing’ means an input PP in which the first direction input is performed by pressing in a vertical direction according to the inclination of a finger in the state in which the finger has been placed on the reference location S (i.e., the finger is placed on the first contact point).

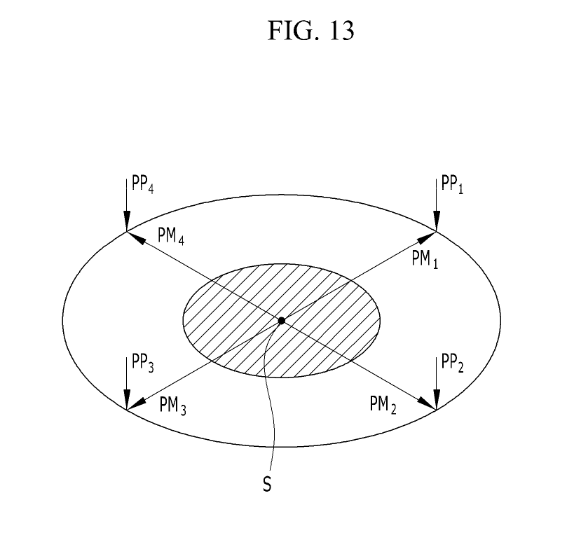

That is, in the vertical pressing, as shown in FIG. 13, specific first indication locations D1 are provided around a face touched by a finger (i.e., an oblique line). In this state, the vertical pressing is performed by inclining and pressing the finger in the first indication location D1.

Meanwhile, the term ‘horizontal pressing’ means an input PM which is performed by pressing in a horizontal direction (including all directions which are not strictly horizontal, but close to the horizontality) although a finger is not moved on an actual space in the first contact point.

That is, referring to FIG. 13, the horizontal pressing means that the detection unit is pressurized to a specific second indication location D2 in the state in which a finger (an oblique line area in the drawing indicates a face touched by the finger) has been placed on the reference location S. In the horizontal pressing, an input is not performed by a finger barely touching the top surface of the detection unit or a similar operation, but the contact point of a finger and the detection unit remains intact.

The detection unit can have various forms. For example, the detection unit may entirely have a circular shape as shown on the right side of a casing 40 in FIG. 12 or may have a square shape as shown on the left side of the casing 40 shown in FIG. 12. Of courses, the detection area can be provided in various ways, if appropriate.

The detection unit detects the pressing of the reference location S by a finger so that a center input PC can be performed. The center input PC is generated by a vertical pressing for the reference location S. When the center input PC is performed, the control unit can extract letters, numerals, data, or a function command, corresponding to the center input PC, from the memory unit and enter the extracted results.

Here, any one of the display window 30 or the detection unit can be provided with a letter display unit 31 for displaying data assigned to the first indication locations D1 and the second indication locations D2. In this case, the letter display unit 31 may convert and display data assigned by the first direction input, the second direction input, or the center input.

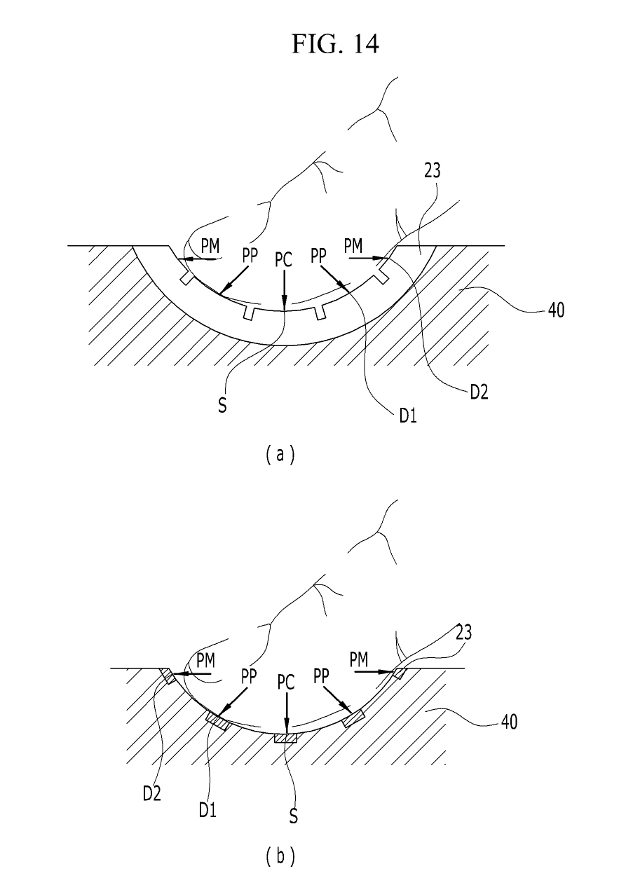

An example of the detection unit is shown in FIG. 14. That is, the detection unit, as shown in FIG. 14(a), can be provided in the form of a piezoelectric detection panel 23 having a concave detection area corresponding to the shape of a face touched by a finger. Here, a plurality of first indication locations D1 and a plurality of second indication locations D2 are radially arranged around the reference location S, located at the center of a face touched by a finger, and are sequentially spaced apart from one another at different intervals in the piezoelectric detection panel 23.

Meanwhile, the piezoelectric detection panel 23, as shown in FIG. 14(b), may be divided and provided in a base 40, having a concave shape, in response to the first indication locations D1 and the second indication locations D2, respectively.

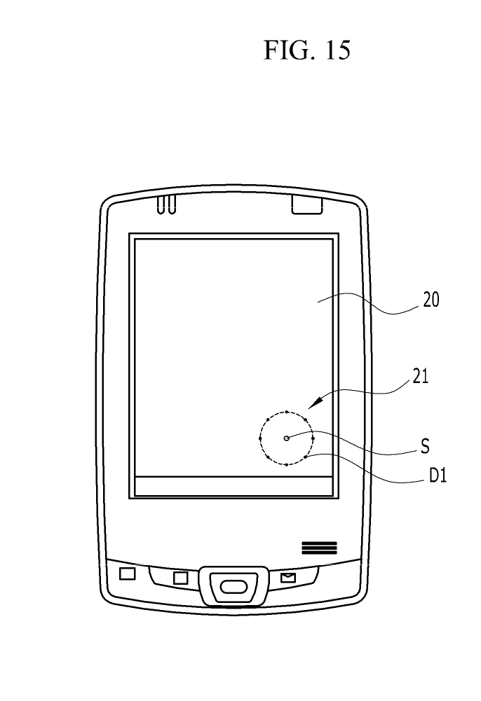

Further, the letter entry device in which the present invention can be implemented may be configured as shown in FIG. 15.

The letter entry device includes a specific detection area 20 in a terminal 100 for an electronic device and uses the detection of the movement of a finger. The letter entry device is characterized in that it includes a detection input unit 21 for performing a direction input corresponding to a contact or pressing by detecting one or more of a contact and pressing for a reference location S which location can be displaced in the detection area 20 and a plurality of first indication location D1 radially arranged around the reference location S; and a control unit (not shown) for determining a finger's contact or pressing point, a contact, or a pressing direction on the basis of the direction input, extracting data assigned to the corresponding contact or pressing from a memory unit (not shown), and entering the extracted data.

The above-described data entry device can be implemented on a touch screen, but not limited to the touch screen so long as a terminal for an electronic device can detect a finger's or tool's contact or pressing and process such detection.

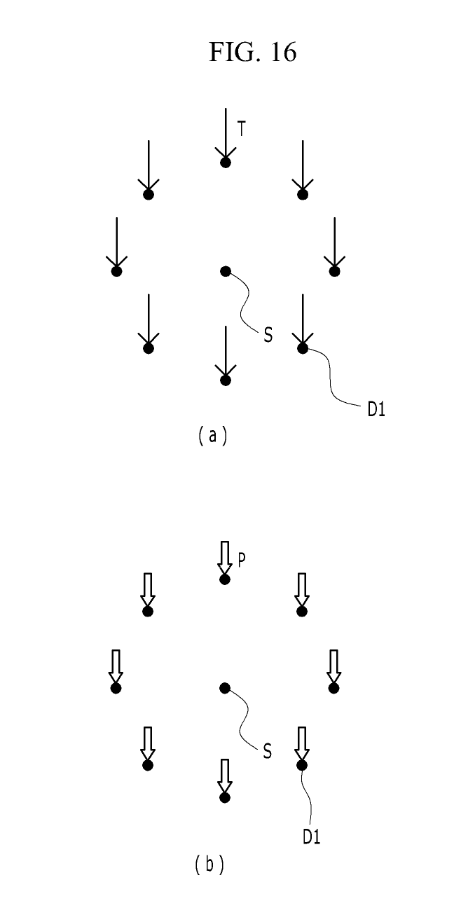

In the above letter entry device, as shown in FIG. 16(a), data assigned to the respective indication locations D1 can be inputted as contact inputs T for the respective indication locations D1. Further, as shown in FIG. 16(b), data assigned to the respective indication locations D1 can be inputted as pressing inputs P for the respective indication locations D1. In addition, as described above, data assigned to the respective indication locations D1 can be inputted as horizontal pressings for the respective indication locations.

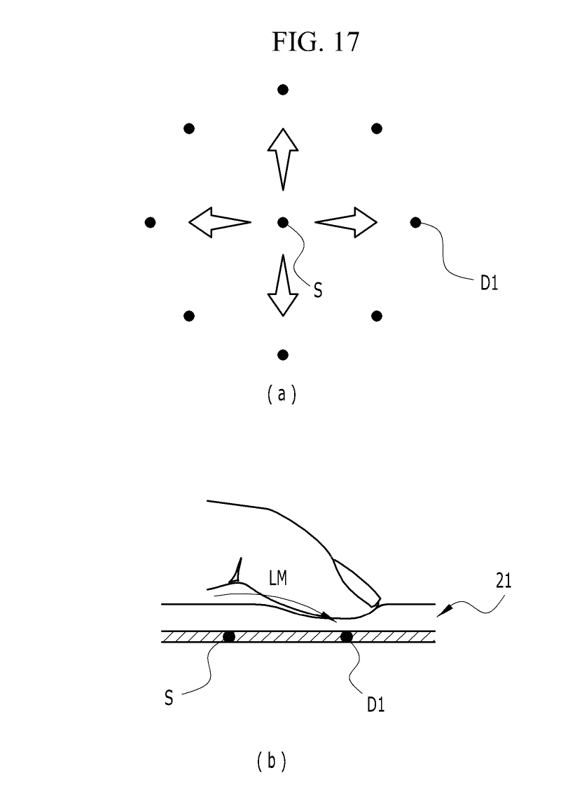

Meanwhile, as indicated by arrows in FIG. 17(a), data may be inputted by an inclination input LM whose pressure is increased while moving outward. In FIG. 17(b), an example in which pressure is increased when a finger moves from a reference location S to a specific first indication location D1 is described.

As described above with reference to the various letter entry devices, the entry of data assigned through a contact, pressing, direction movement or an inclination for a reference location is called a center input. Here, the reference location can be provided with an enter key capable of performing one or more of a contact, pressing, direction movement and an inclination, a touch pad capable of detecting a contact or direction movement a piezoelectric detection panel capable of detecting pressing, or the like.

A plurality of first indication locations is arranged at respective locations radially arranged around the reference location and spaced apart from one another. A contact, pressing, direction movement or an inclination for the first indication locations is called the first direction input.

Further, a plurality of second indication locations can be provided at respective locations which are radially arranged around each of the first indication locations and spaced apart from one another. A contact, pressing, direct movement or an inclination for the second indication locations is called a second direction input.

It is common that different data are assigned to the center input, the first direction input, and the second direction input. However, the same data can be assigned to at least two of the center input, the first direction input, and the second direction input. Alternatively, although different data may be assigned to the contact, the pressing, the direction movement, and the inclination in each of the center input, the first direction input, and the second direction input, the same data can be assigned to at least two of the contact, the pressing, the direction movement, and the inclination.

Meanwhile, when prediction activation is performed by an inclination from among direction movement pressing, and the inclination, a prediction suggestion can be made in response to the direction movement or the pressing in each direction. When a letter entry is performed in response to the direction movement or the pressing, the prediction suggestion can always be performed in the inclination. Alternatively, when a center key or a prediction activation key, such as an additional key, is pressed, the prediction suggestion can be made in response to the direction movement, the pressing, or the inclination.

Further, the above three methods can be configured to expand a prediction suggestion through a combination of the direction movement and the direction movement (i.e., a direction and direction combination). For example, when a prediction letter suggested in any one direction of an inclination, prediction letters (words) (derivatives, compounds) further advanced from the prediction letter are suggested in response to direction movement or pressing. Further, the prediction letters can be further consecutively extended and suggested.

In addition, in the case in which direction movement or pressing is a letter entry and an inclination is a prediction input, prediction letters for the direction movement or the pressing can be displayed in the respective directions of the inclination and can be selected by an inclination.

In the state in which the input of the inclination has remained intact, words, such as an advanced prediction letter, a derivative letter, a variation, a similarity, and a synonym, which are related to a prediction letter selected by the inclination in response to direction movement or pressing are further suggested. A specific word may be selected from the suggested words through direction movement or pressing.

For example, a process of entering [symbol] is described below. First, when [symbol] is entered, several words starting from [symbol] appear (derivative from an original form). The words can include, for example, [symbol] and [symbol] If [symbol] is selected from the words, several derivative prediction letters are suggested. When [symbol] is selected from the suggested derivative prediction letters, the selection of [symbol] is completed.

Embodiments of the present invention which can be implemented in the above-described letter entry device are described in detail.

### First Embodiment

The present embodiment relates to a method of switching to a prediction letter entry mode by performing the center input or pressing an additional key and then entering a prediction letter. That is, after premise letters are entered through a first direction input and a second direction input (step S10), when the center input or the input to press an additional key is performed, prediction letters based on the premise letters are arranged in the first indication locations and the second indication locations (step S20). Here, if there is an intended letter from among the arranged prediction letters, the first direction input or the second direction input is performed in order to enter the corresponding prediction letter (step S30).

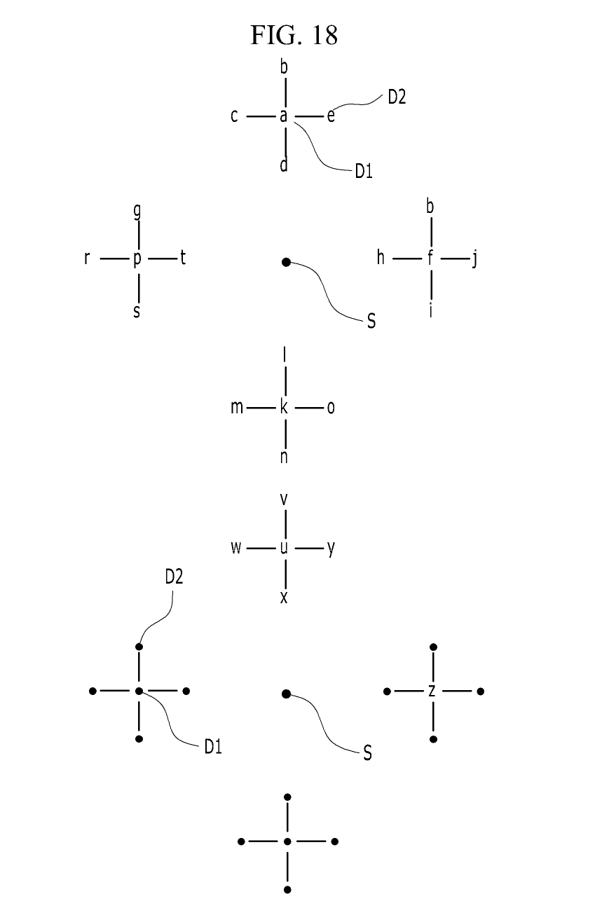

For example, in order to enter an English word ‘station’, ‘sta’ is entered as premise letters through a first direction input or a second direction input, as shown in FIG. 18. Here, the first direction input and the second direction input are assigned to the first indication locations and the second indication locations arranged around the reference location and then performed with reference to the display window or the letter display units displayed in the first indication locations and the second indication locations.

That is, as shown in FIG. 18, in the case in which the alphabet is arranged in the first indication locations and the second indication locations, ‘s’ is entered by performing the second direction input for the second indication locations arranged in the 6 o'clock direction of the first indication locations in the 3 o'clock direction in a letter arrangement group on the left side, ‘t’ is entered by performing the second direction input for the second indication locations arranged in the 3 o'clock direction of the first indication locations in the 3 o'clock direction, and ‘a’ is entered by performing a first direction input for the first indication locations in the 12 o'clock direction.

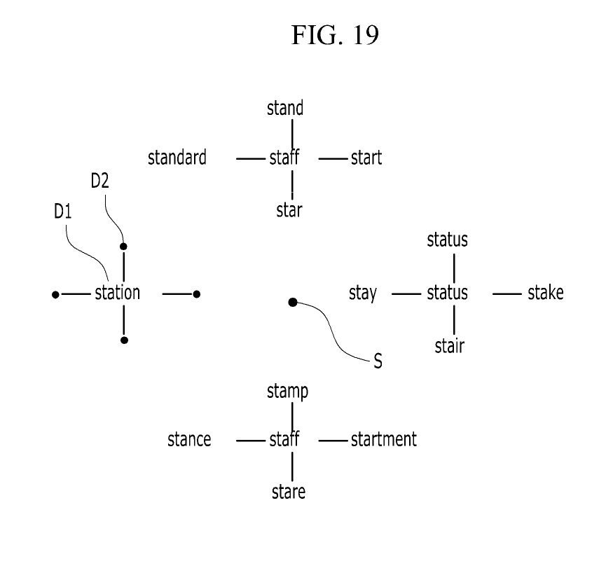

After the three letters are entered, when the center input in the reference location is performed, the letter arrangement group is switched to a prediction word group, including the premise letters, on the basis of ‘sta’ (i.e., the premise letters) as shown in FIG. 19. Here, although all English letters starting from ‘sta’ may be displayed in the prediction word group, only letters having a high frequency of use can be selectively arranged. If the selected words are arranged, 16 words can be arranged as shown in FIG. 19.

Here, since an intended word is arranged in the first indication locations of the 9 o'clock direction, a word ‘station’ can be entered by performing the first direction input for the first indication locations.

In the case in which the premise letters consist of only two letters, more words can be arranged in the prediction word group. Here, prediction words are arranged in the prediction word group. In the case in which all letters cannot be arranged on one screen, the corresponding screen may be switched to another screen in order to view another prediction word group through a center input or an input using an additional key.

Here, the number of letters constituting premise letters is not limited to two or three. With a reduction in the number of letters, the number of prediction words is increased, and with an increase in the number of letters, many letters should be entered as premise letters. Accordingly, it is preferred that the number of premise letters be two or three.

A modified example of the present embodiment is described below.

In the present modified example, when premise letters are entered (step S10) and a mode is switched to a prediction word entry mode through the center input or the input using an additional key, the original form of the premise letters is displayed in a prediction word group (step S20). Here, when a first direction input or a second direction input is performed in order to enter the original form of an intended word from among the original form entered in the prediction word group (step S30), derivative words for the original form are arranged in the prediction word group at the same time (step S31). Accordingly, the input for intended words can be completed by selecting the derivative words for the original form in the state in which the original form has been selected (step S32).

More particularly, as shown in FIG. 18, in the case in which the alphabet is arranged in each of first indication locations and second indication locations, the first and second letters of an intended word are entered through a first direction input for the first indication locations and a second direction input for the second indication locations. The two entered letters become premise letters.

After the premise letters are entered, the prediction word entry mode is performed in response to the center input or the input using an additional key. When the prediction word entry mode is performed, the original forms of a word, including the premise letters, are arranged in the first indication locations and the second indication locations.

If an intended word exists in the arranged original forms of the word, a first direction input or a second direction input is performed through the first indication locations or the second indication locations in which the original forms of the word are arranged, and the input is then released.

However, if the original form of the word is not an intended word, but a word derived from the original form is an intended word, the first direction input or the second direction input is performed again in the state in which the original form of an intended word has been selected through the first direction input or the second direction input. Here, when the original form of the word is selected, derivative words of the selected original form are arranged in the first indication locations and the second indication locations. Accordingly, in the state in which the original form has been selected, an intended word can be selected from the derivative words of the original form.

Through the above method, in the present invention, after 1 or 2 premise letters are entered, a word to be entered can be easily searched for and entered through input and selection 3 to 4 times by selecting an original form and then selecting extended derivative words. In the prior art, entries should be typically performed 3 or more times in order to find a specific original form. In the present invention, however, when premise letters are entered through 1 to 2 input operations, a plurality of original forms of a word having a high frequency of use is suggested. Accordingly, a desired word can be rapidly searched for and entered through a small number of input operations.

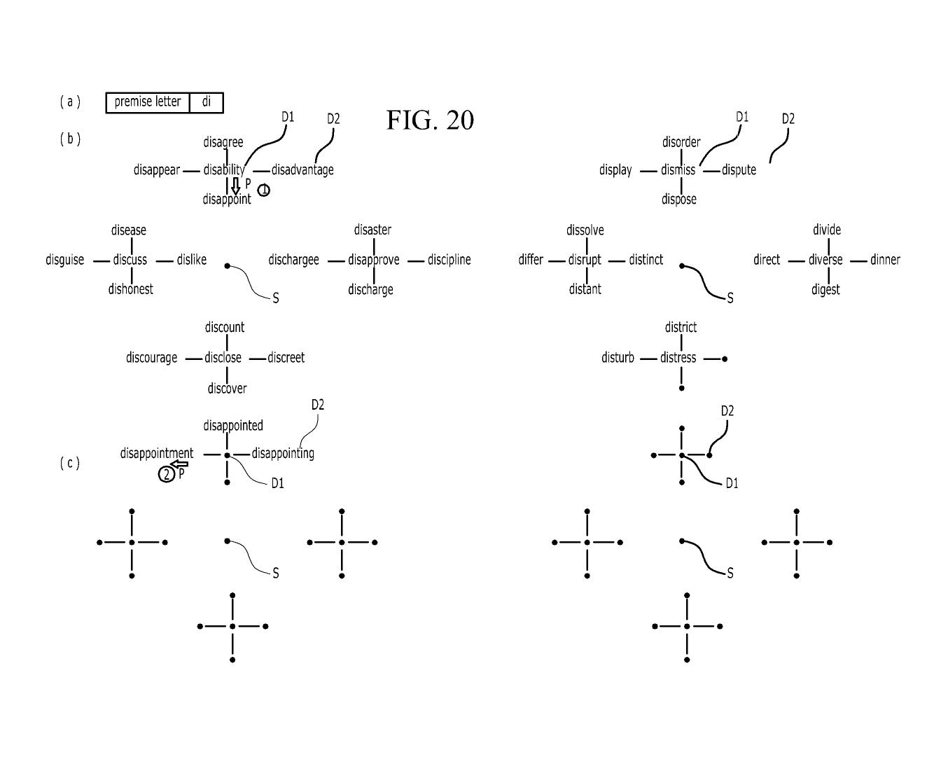

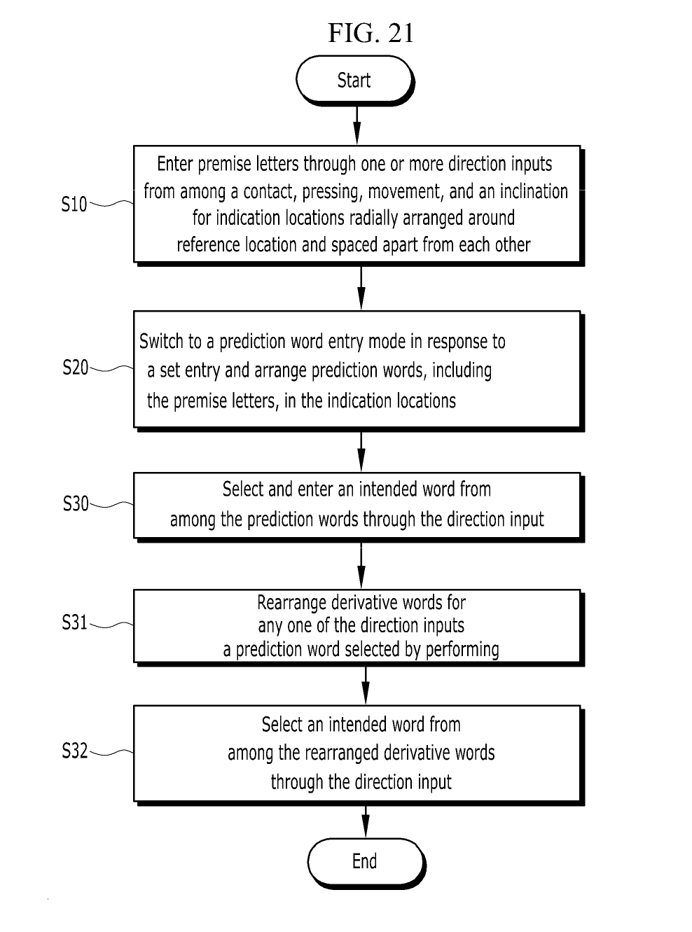

For example, as shown in FIG. 20(a), ‘di’ are entered as premise letters through a first direction input and a second direction input. Next, a prediction word entry mode is performed in response to the center input or the input using an additional key.

In the prediction word entry mode, various original forms including ‘di’ (i.e., the premise letters) are arranged. Here, assuming that an intended word is ‘disappointment’, ‘disappoint’ which is the original form of the word ‘disappointment’ is selected through a first direction input or a second direction input (\textcircled{1} in FIG. 20(b)).

When the original form ‘disappoint’ is selected, derivative words of the original form are rearranged in first indication locations and second indication locations as shown in FIG. 20(c). Here, since the derivative words of the original word ‘disappoint’ include ‘disappointed’, ‘disappointing’, and ‘disappointment’, the three words are arranged in the second indication locations around the first indication locations of the 12 o'clock direction. Accordingly, the intended word is selected by performing a second direction input for the second indication locations of the 9 o'clock direction in which the intended word ‘disappointment’ is arranged in the state in which the original form has been selected (\textcircled{2} in FIG. 20(c)).

Such a switch to the prediction word entry mode may be performed by performing the center input (or the input using an additional key) in a reference location after premise letters are entered through a direction input. Alternatively, the switch to the prediction word entry mode may be performed by performing the center input in the state in which premise letters have been entered through a direction input.

Accordingly, a direction movement input or a pressing input may be performed in the state in which the center input has been performed in a reference location after the direction movement entry is performed during a direction input (i.e., a state in which a switch to the prediction word entry mode has been performed) or the center input is performed in the state in which a direction movement input has been performed (that is, the switch to the prediction word entry mode is performed), and a pressing input may be then performed.

In the above, in the state in which the direction movement entry or the pressing input for selecting a prediction word has been performed, an extended input can be consecutively performed by further performing a direction input.

Meanwhile, the entry of a prediction word can also be performed in response to a combination of a direction input and a direction input. In this case, the combination of the direction inputs is not performed only in the state in which any one direction input has been performed, but can be performed by performing each of the direction inputs. Here, an extension from the original form of a prediction word to derivative words of the original form is performed on condition that another direction input is performed in the state in which a direction input (i.e., in a prediction step) has been performed (refer to FIG. 20(b)).

However, in the case in which the center input or the input using an additional key is used, a state in which the prediction word is active continues during the time for which the center input or the input using an additional key is performed. Accordingly, two or more direction inputs can be separately performed.

The entry of a prediction word in each of the embodiments is not performed by performing a specific direction input in the state in which the center input has been performed, but may be performed by performing the center input and then performing a specific direction input in the state in which the center input has been released.

Further, the prediction word may be displayed in the display window or continues to be displayed when the prediction word entry mode is performed.

Furthermore, the direction input in each of the embodiments can become any one of direction movement pressing, and an inclination.

### Second Embodiment

In order to perform the prediction word entry mode as described above, the center input or the input using an additional key may be performed, but the prediction word entry mode may be performed in response to a combination of direction inputs. That is, in the present embodiment, in the case in which direction inputs can be divided into a first direction input and a second direction input, a mode can be switched to the prediction word entry mode by consecutively performing the first direction input and the second direction input. Here, the term ‘consecutive input’ means that each input operation is consecutively performed in the state in which a finger is not detached from a letter entry device.

Alternatively, in the case in which a direction input is performed only through a first direction input and the first direction input is divided into direction movement pressing, and an inclination, a mode may be switched to a prediction word entry mode by consecutively performing the direction movement and the pressing or by consecutively performing the direction movement, the pressing, and the inclination. Alternatively, a mode may be switched to the prediction word entry mode by performing any one of the direction movement, the pressing, and the inclination.

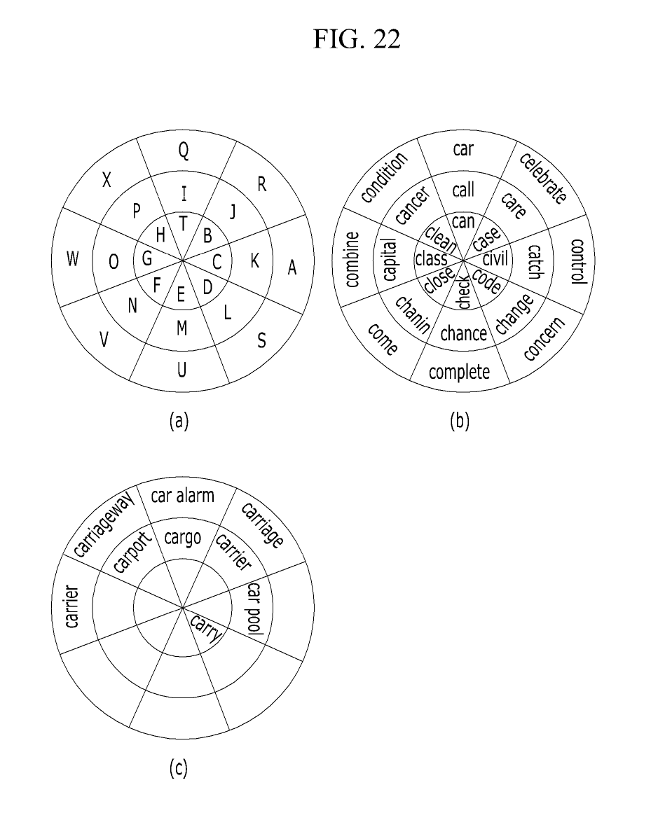

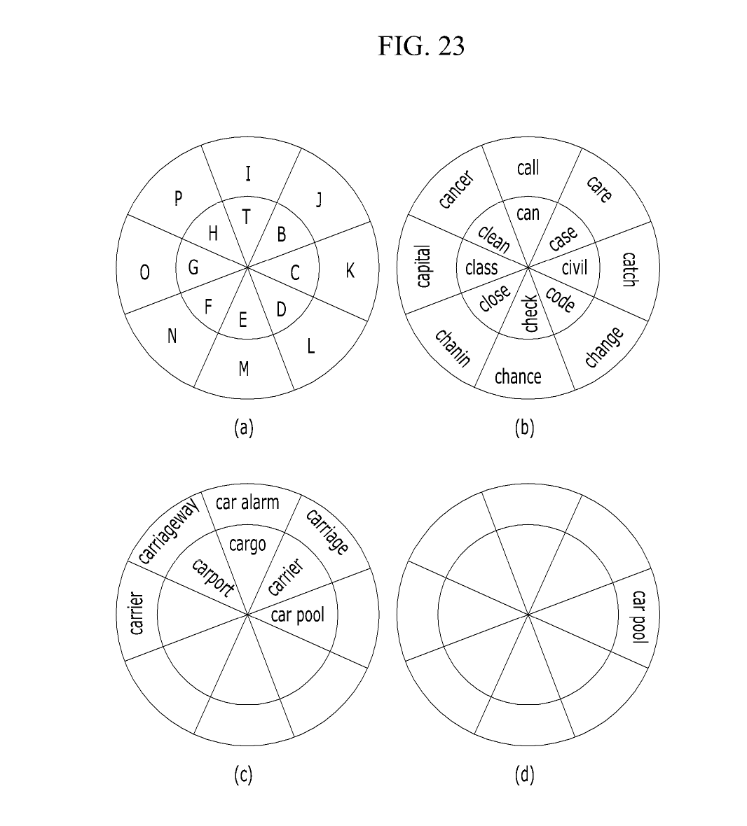

The entry of a prediction word is described in more detail with reference to FIGS. 22 and 23. For reference, the letter display unit 31 shown in FIGS. 22 and 23 can be displayed in the letter entry device 10′ or the display window 30 of FIG. 12. Here, in the case in which the letter display unit 31 is displayed in the letter entry device 10′, it is displayed in the form of FIG. 22(a) or FIG. 23(a), and the letter display unit 31 modified by a direction input is displayed in the display window 30.

Alternatively, in the case in which the display window 30 of FIG. 12 is composed of a touch screen, a direction input may be directly performed on the letter display unit 31 displayed in the display window 30. In this case, the letter display unit 31 in itself can be changed when the direction input is performed, or an additional letter display unit for displaying a prediction word may be provided outside of the letter display unit 31 and the prediction word may be displayed in response to a direction input.

Meanwhile, in the letter display unit 31 shown in FIG. 22, letters arranged in a first column can be selected in response to direction movement letters arranged in a second column can be selected by a pressing, and letters arranged in a third column can be selected by an inclination.

Further, in the letter display unit 31 shown in FIG. 23, letters arranged in a first column can be selected in response to direction movement, and letters arranged in a second column can be selected by a pressing. Accordingly, in this case, an inclination can be used as an input for performing a prediction word entry mode. Alternatively, the letters arranged in the first column may be selected by a pressing, the letters arranged in the second column may be selected by an inclination, and direction movement may be used as the input for performing the prediction word entry mode.

In the entry of a prediction word in the present embodiment, premise letters are first entered through direction movement. In this case, although the center input or the input using an additional key may be performed in order to activate the prediction word, the prediction word may be activated by maintaining a state in which the premise letters have been entered.

For example, in order to enter ‘car’ in a common mode in the letter display unit shown in FIG. 22(a), ‘c’ is entered through direction movement to the 3 o'clock direction, ‘a’ is entered through an inclination toward the 3 o'clock direction, and ‘r’ is then entered through an inclination toward a 1 o'clock direction. That is, the three letters constituting the word ‘car’ must be separately entered.

If the three letters are entered through a prediction word entry mode, ‘c’ is entered through direction movement to the 3 o'clock direction in the letter display unit 31 shown in FIG. 22(a). In this state, a finger that has performed the direction movement remains touching the letter display unit. A group of prediction words including ‘c’ is arranged in the letter display unit 31 shown in FIG. 22(a), as shown in FIG. 22(b). In this state, when an inclination input is performed in the 12 o'clock direction, ‘car’ placed in the 12 o'clock direction of a third column in the letter display unit is entered.

Here, in the case in which another word including ‘car’ is sought to be entered, the inclined state remains intact in order to enter the word ‘car’. Accordingly, a group of prediction words including ‘car’ is rearranged in the letter display unit 31 as shown in FIG. 22(c). In this case, if ‘car pool’ is sought to be entered, it can be selected through a pressing in the 3 o'clock direction.

Meanwhile, the entry of a prediction word according to the present embodiment may be performed using any one of direction movement pressing, and an inclination as an input for activating the prediction word.

That is, after premise letters are entered through direction movement prediction words may be activated by an inclination, and an intended word may be selected from among prediction words activated by a pressing. Here, the entry of the premise letters may be of course performed by direction movement and pressing.

Alternatively, after premise letters are entered through direction movement prediction words may be activated by an inclination, and an intended word may be selected from among prediction words activated by direction movement. Even in this case, the entry of the premise letters may be of course performed by direction movement and a pressing.

For example, as shown in FIG. 23, a first column can be selected in response to direction movement, a second column can be selected by a pressing, and ‘c’ can be entered by performing direction movement to the 3 o'clock direction in order to enter ‘car’ in the letter display unit 31 in which a prediction word entry mode can be switched by an inclination.

If an inclination is performed in this state, a mode is switched to the prediction word entry mode. In this case, since there is no letter in the letter display unit 31 as far as the inclination concerned, a user can immediately switch to the prediction word entry mode by performing an inclination input to a convenient location.

After the mode is switched to the prediction word entry mode, a prediction word group including ‘c’ is arranged in the letter display unit as shown in FIG. 23(b). Here, in order to enter ‘car’ written in the 12 o'clock direction of the second column in the letter display unit 31, a pressing is performed in the 12 o'clock direction press. Accordingly, the entry of ‘car’ is completed.

In the case in which letters including ‘car’ are sought to be entered, if the pressing in the 12 o'clock direction remains intact in order to enter ‘car’, a prediction word group including ‘car’ is arranged in the letter display unit 31, as shown in FIG. 23(c). In this case, if ‘car pool’ is sought to be entered, direction movement to the 3 o'clock direction is performed, and thus ‘car pool’ arranged in the 3 o'clock direction of the first column in the letter display unit 31 is selected.

Further, if letters including ‘car pool’ are sought to be displayed by further extending the above, the state in which ‘car pool’ has been selected remains intact. Accordingly, ‘car pool lane’ which is a word including ‘car pool’ is displayed in the letter display unit 31, as shown in FIG. 23(d).

Accordingly, if the ‘car pool lane’ is a finally intended word, the word is entered by performing a pressing in the 3 o'clock direction. Alternatively, if up to the ‘car pool’ is an intended word, the entry of letters is finished in the state in which no entry has been performed in the letter display unit shown in FIG. 23(d).

Meanwhile, in the present embodiment, in addition to the above entry methods, similar to the embodiment shown in FIG. 20, after premise letters are entered through direction movement the original forms of a prediction word may be activated through an inclination, the original form of an intended word may be selected from among the original forms of the prediction word through direction movement and derivative words of the intended word may be finally selected through a pressing. In this case, if the original form of a word is selected, derivative words for the original form of the word can be arranged as shown in FIG. 20(c).

In the case in which the above-described entry method is applied to the English language, an English sentence can be entered easily and fast. Further, the method of predicting and entering a word according to the present invention can be applied to other languages (i.e., Korean, Chinese, or Japanese) in addition to the English language. In particular, if the method is applied to Chinese or Japanese, the method can be used on the basis of pronunciation displayed when Chinese or Japanese is read in the form of English or Korean.

Further, if premise letters are entered and a mode is switched to a prediction word entry mode as described above, the original form of a word including the premise letters is arranged. When the original form is selected, derivative words for the original form are arranged. However, if a mode is switched to the prediction word entry mode without entering premise letters, the parts of speech may be arranged in respective indication locations. In this case, if a direction input to the indication locations in which any one of the parts of speech is placed is performed, words belonging to the parts of speech can be arranged, and an intended word can be selected from the arranged words.

Furthermore, in the present invention, although letters are not entered in order of the arrangement of words when a specific word is entered on the basis of the alphabet, such as that shown in FIG. 18, words including the entered letters can be arranged. In other words, in the case in which letters are entered out of order, words including the entered letters may be arranged in respective indication locations, and an entry may be performed by performing a direction input to an indication location in which an intended word is placed.

More particularly, if ‘a’, ‘g’, and ‘e’ are not entered in order in order to enter ‘age’, ‘gae’ or ‘ega’ can be entered. Here, if the three letters are entered, words, such as ‘age’, ‘gae’, and ‘ega’ including the three letters, are arranged in respective indication locations. In this case, a user can select the ‘age’ by performing a direction input to an indication location in which the intended word ‘age’ is placed.

Here, the methods described in the above embodiments, such as the center input or the input using an additional key, can be used as a method of displaying words in respective indication locations.

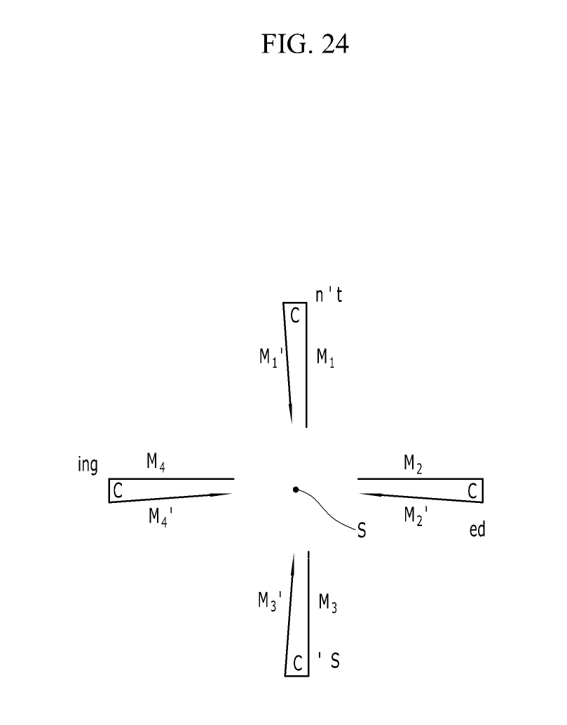

Meanwhile, referring to FIG. 24, the infinitive form, the past form, the plural form, or the progressive form of a letter entered by a center direction input MOM, . . . may be selected.

Referring to the drawing, for example, if a negative form is sought to be entered while letters are consistently entered through the letter entry device 1 according to the present invention, a first direction input M₁ in the 12 o'clock direction is performed at a reference location S. After performing the center input C and then returning to the reference location S through a first direction input M′₁, a negative form ‘n′t’ can be entered at once.

Likewise, when a first direction input M₂, the center input C, and a first direction input M′₂ to the reference location S are performed in the 3 o'clock direction, a past form ‘ed’ can be entered at once.

More particularly, when a letter ‘d’ is entered and the above-described center direction input MOM, . . . , is then performed, ‘don't’, ‘did’, ‘do’, ‘doing’, etc. are activated and displayed in letter display units 74 when the center input C is performed, and a desired letter is entered through a direction input to a corresponding direction.

### Third Embodiment

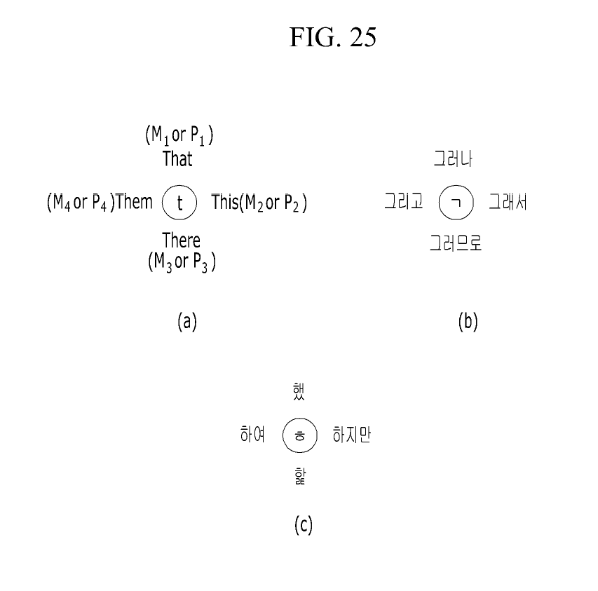

The method of predicting and entering letters is described in detail with reference to FIGS. 25 to 35.

In the present specification, the method of predicting and entering letters refers to a method of, when a user enters some of desired letters, automatically searching for a word or a sentence starting from the corresponding letters, displaying the retrieved results in the letter display units 74, and allowing the user to select one of the retrieved results through a simple operation, thereby reducing the number of input operations and accurately entering a desired word or sentence.

In the letter entry device 1 according to the present invention, in the method of predicting and entering letters, when the center input C is performed in the state in which letters have been entered by performing the direction input (i.e., a first direction input M or a second direction input P which is the same hereinafter) in a reference location or a location has returned to a reference location S after letters are entered, prediction letters are activated on the basis of a letter entered last. A user selects prediction letters through he first direction input M, the second direction input P, or direction combination inputs MP and PM.

Here, the activation of prediction letters through the center input C is described in more detail. Referring first to FIG. 25(a), when the center input C is performed after a letter ‘t’ is entered by performing the first direction input M or the second direction input P, ‘that’, ‘this’, ‘there’, and ‘them’ for respective direction indication locations are activated in a display unit 130.

In this case, a user enters a desired word at once by performing the first direction input M or the second direction input P in a direction in which a word to be entered is activated. In general, the activated words or sentences may be displayed in order of a higher frequency of use or may be controlled and displayed in order of the frequency which is used by a user and stored in each terminal.

Alternatively, in the case in which the number of activated words or sentences is 4 or more, the activated words or sentences may be selected by increasing the number of direction indication locations or by configuring the center input C in multiple stages and changing the activated letter display units 72.

Such a prediction letter entry can be applied to not only an alphabet entry mode, but also a Korean entry mode. FIG. 25(b) shows an example in which after a Korean letter ‘ [symbol] ’ is entered, the center input C is selected to activate a prediction letter. FIG. 25(c) shows an example in which after a Korean letter ‘ [symbol] ’ is entered, the center input C is selected to activate a prediction letter.

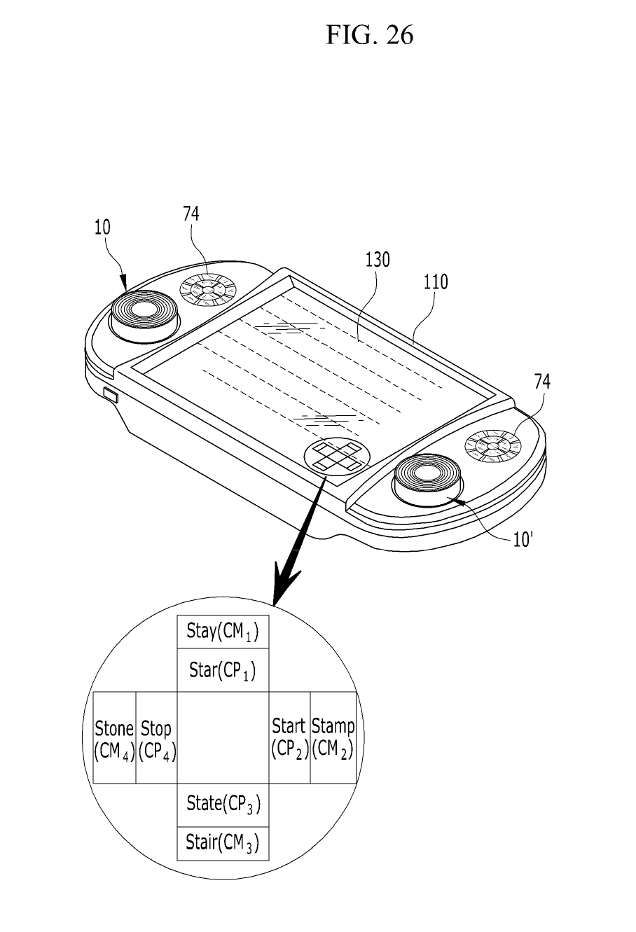

Meanwhile, FIG. 26 shows an example in which the first direction input M and the second direction input P can be selected and entered at the same time for every direction indication locations in the activation of a prediction letter.

That is, when the center input is selected after a letter ‘s’ is entered through the letter entry device 1 of the present invention, a prediction letter table, such as that shown in the drawing, is activated.

Here, a word relatively close to the reference location S for each direction indication location indicates a word entered by the second direction input P in a corresponding direction, and a word relatively distant from the reference location S for every direction indication location indicates a word entered by the first direction input M.

Accordingly, when a second direction input P₁ is performed in the 12 o'clock direction after the center input C is selected, a word ‘star’ is entered. When the first direction input M₁ is performed in the 12 o'clock direction after the center input C is selected, a word ‘stay’ is entered.

Likewise, when a second direction input P₂ is performed in the 3 o'clock direction after the center input C is selected, a word ‘start’ is entered.

Meanwhile, the method of predicting and entering letters can be performed through not only a combination of the center input C and the direction input, but also a combination of the direction input and the direction input. In other words, when the first direction input is performed, a prediction letter of the first direction input may be displayed in the second direction input. When the second direction input is performed, a prediction letter of the second direction input may be displayed in the first direction input.

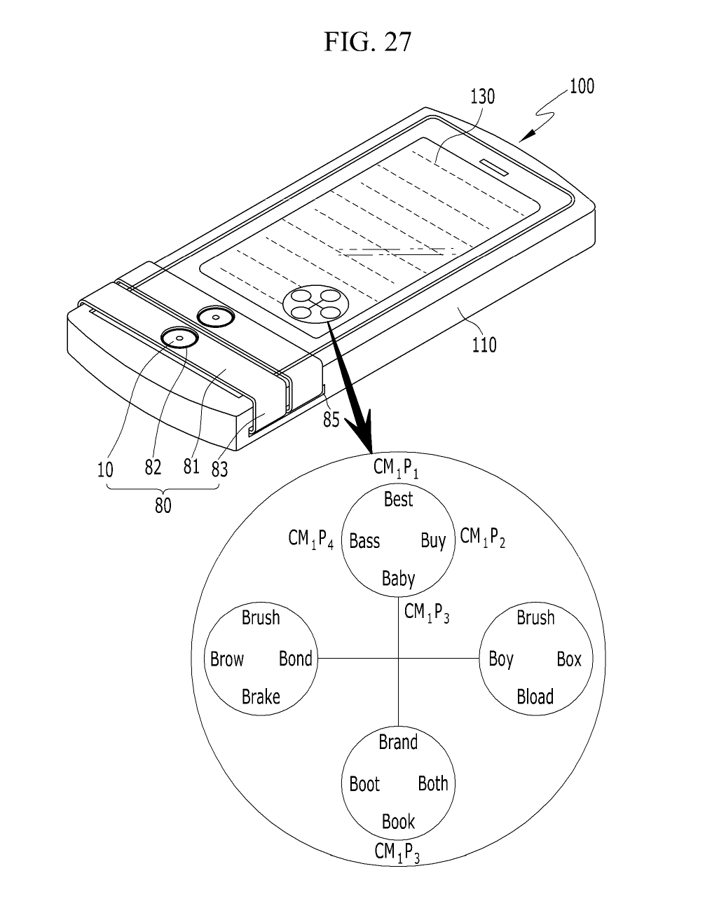

Referring to FIG. 27, when the center input C is selected after a letter ‘b’ is entered, a mode is switched to a prediction letter mode. However, a prediction letter table has not yet been activated in the display unit 130.

The prediction letter table is activated and displayed for every second direction indication locations P₁, P₂, . . . , after the first direction input M1 is performed in the 12 o'clock direction.

That is, a letter ‘best’ is entered through the steps of entering the letter ‘b’→performing the first direction input M1 in the 12 o'clock direction→activating the prediction letter table→performing the second direction input P1 in the 12 o'clock direction.

Likewise, in the above-described example, when the second direction input P2 is performed in the 3 o'clock direction after the prediction letter table is activated, a word ‘buy’ is entered.

In this case, the entry of a prediction letter using direction combination inputs can be performed by first performing the second direction input P and then performing the first direction input M in a corresponding direction after a prediction letter table is activated.

Accordingly, as described above, when a prediction letter is activated through the center input C and any one of the first direction input M and the second direction input P is entered through the prediction letter, if each of the direction inputs has four direction indication locations, 8 letter entries on each of the left and right sides in one input unit 10, that is, a total of 16 letter entries are possible.

Alternatively, when the number of prediction letters is many, in the case in which the entry of letters is performed in response to the above direction combination inputs MP and PM, 16 letter entries are possible in one input unit 10, and a total of 32 letter entries are possible on the left and right sides.

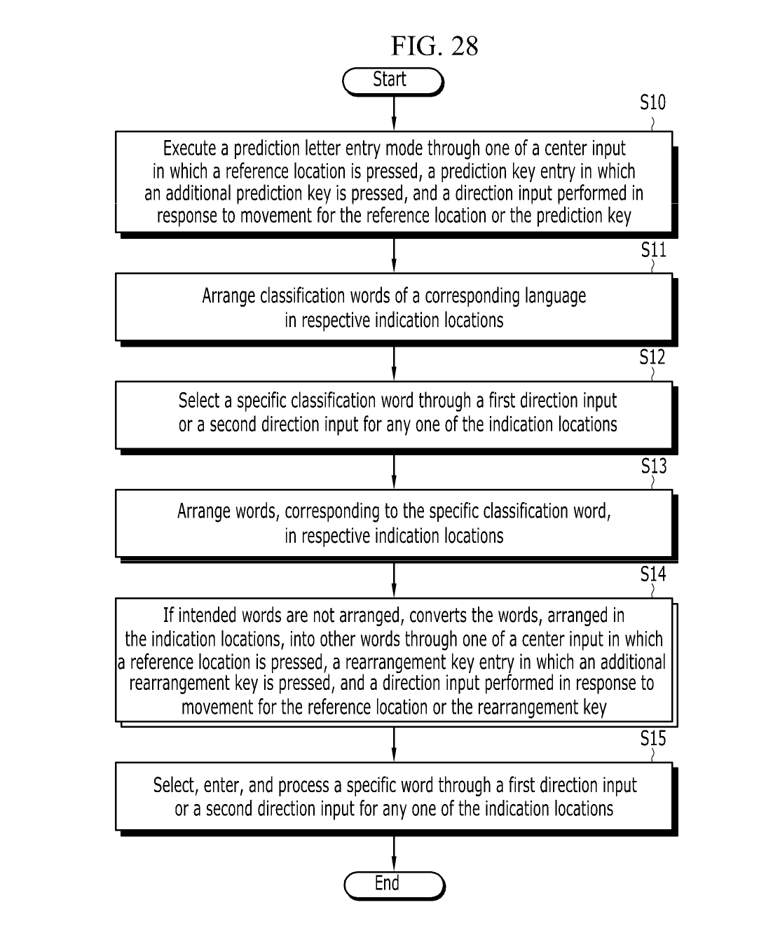

FIGS. 28 to 35 are diagrams showing another example of the method of predicting and entering letters.

FIGS. 28 to 31 show a method of entering parts, such as the subject, a verb, an object, and an adverb of a sentence to be entered using the enter key, by selecting the parts-of-speech name or a corresponding word displayed in the letter display unit.

More particularly, first, a predetermined entry is performed in order to switch a letter entry mode to a prediction letter entry mode. That is, one or more of the center input in which a reference location S is pressed, the prediction key entry in which an additional prediction key (not shown) is pressed, and the direction input performed in response to movement for the reference location S or the prediction key are selected as a command for switching the letter entry mode to the prediction letter entry mode. Further, a common letter entry mode is switched to the prediction letter entry mode by performing an entry, selected as described above, from among the entries (step S10).

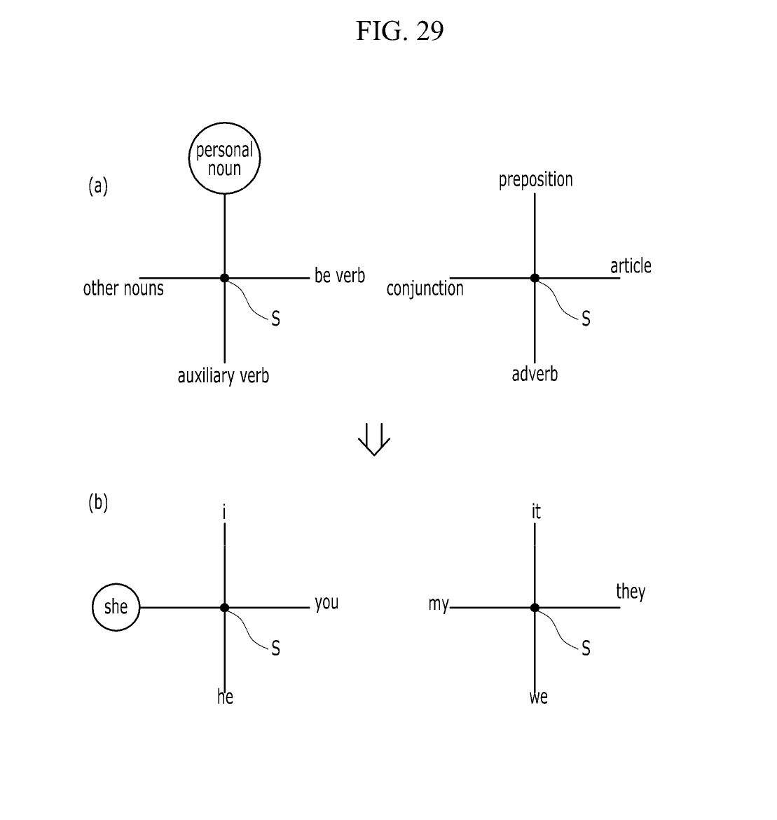

After the letter entry mode is switched to the prediction letter entry mode, the parts of speech of a corresponding language (e.g., English) for the entry of a prediction letter in respective indication locations C arranged in four directions in FIG. 24 are disposed in the letter display unit. Although FIG. 29 illustrates a letter display unit in which the parts of speech arranged in four directions are provided in two pairs each around the reference location S, the letter display unit may include a pair of the parts of speech arranged in eight directions or two pairs of the parts of speech arranged in eight directions.

Further, the contents displayed in the letter display unit are continuously changed in an entry process. It is therefore preferred that the letter display unit be displayed in the display unit (refer to 30 of FIG. 2 or 5) in order to indicate changed contents.

It is also preferred that the parts of speech be composed of things having a limited number of words which are frequently used when a sentence is configured in a corresponding language (hereinafter referred to as a ‘classification word’). For example, the classification word, as shown in FIG. 29, can be composed of personal pronouns such as ‘I’, ‘you’, ‘he’, and ‘she’, other pronouns such as ‘this’, ‘one’, ‘such’, and ‘everything’ other than personal pronouns, auxiliary verbs such as ‘can’, ‘will’, and ‘must’, Be verbs such as ‘an’, ‘am’, ‘are’, and ‘is’, preposition such as ‘in’, ‘with’, and ‘of’, conjunctions such as ‘and, ‘or’, and ‘but’, adverbs such as ‘very’, ‘much’, and ‘already’, and articles such as ‘a’ and ‘the’ (step S11).

In order to enter any one of the classification words displayed in the letter display unit, the first direction input M in which movement to an indication location corresponding to the classification word is performed and the second direction input P in which the indication location is pressed can be selected and performed. Here, if the first direction input M and the second direction input P are independently performed, two or more classification words may correspond to each of the indication locations (step S12).

Further, if a specific classification word corresponding to the indication location is selected, words corresponding to the classification word are arranged on the letter display unit. In this case, it is preferred that the words be arranged in order of a higher frequency of use (step S13).

If an intended word exists in the arranged words, the corresponding word is selected by performing the first direction input M or the second direction input P. If an intended word does not exist in the arranged words, words displayed in the letter display unit are rearranged to become other words. Such rearrangement can be performed by performing one or more of the center input in which a reference location S is pressed, a rearrangement key entry in which an additional rearrangement key (not shown) is pressed, and the direction input performed in response to movement for the reference location S or the rearrangement key (step S14).

If an intended word is searched for in the rearranged letter display unit, an entry is process by selecting the corresponding word through the first direction input M or the second direction input P (step S15).

The above process is described as an example.

If an English sentence called “She can everything” is sought to be entered using the method of predicting and entering letters, a letter entry mode is switched to a prediction letter entry mode through any one of the center input, the prediction key entry, and the direction input.

Accordingly, a letter display unit, such as that shown in FIG. 29(a), appears. Here, since the first word “she” of the sentence is a personal pronoun, the personal pronoun part in the letter display unit is selected through the first direction input or the second direction input.

Through such selection, the letter display unit is converted into a letter display unit composed only personal pronouns as shown in FIG. 29(b). Since “she” appears in the 9 o'clock direction on the left side in the converted letter display unit, the “she” is selected and entered by performing the first direction input M or the second direction input P for the “she.”

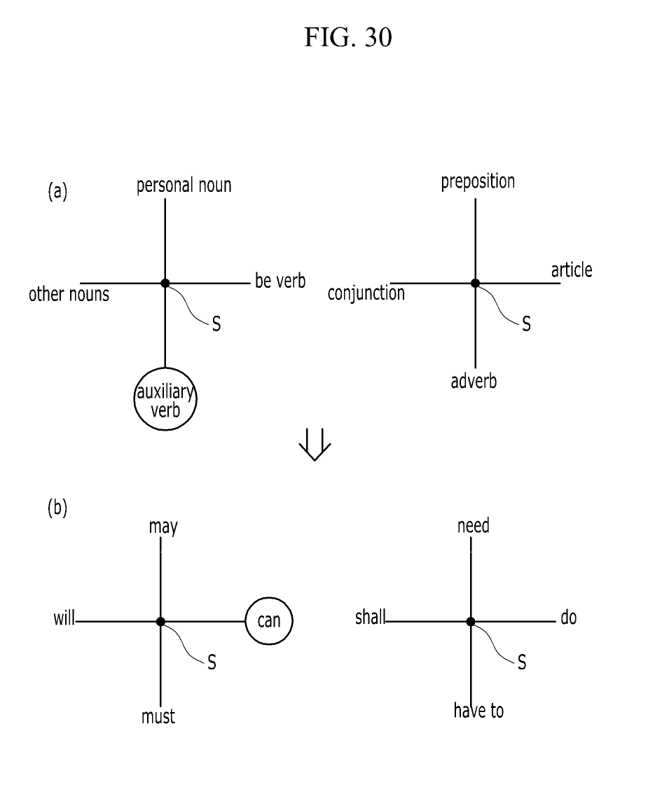

When the “she” is entered, the letter display unit is converted into a letter display unit, such as that shown in FIG. 29(a), as shown in FIG. 30(a). Here, in order to enter a word “can” after the “she,” an auxiliary verb which is the classification word to which the “can” belongs is selected. That is, in the letter display unit shown in FIG. 30(a), an auxiliary verb in the 6 o'clock direction on the left side is selected through the first direction input M or the second direction input P.

Accordingly, as shown in FIG. 30(b), a letter display unit composed of only the auxiliary verb is created. In the created letter display unit, “can” exists in the 3 o'clock direction on the left side. Accordingly, the first direction input M or the second direction input P for entering the “can” is performed.

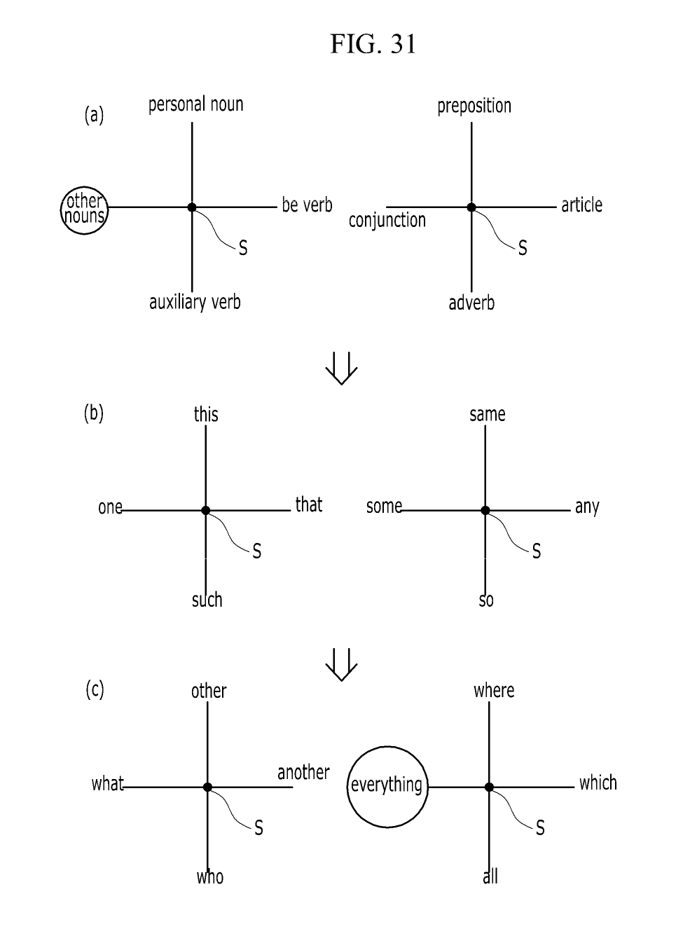

After the “can” is entered, a letter display unit, such as that shown in FIG. 29(a), is created as shown in FIG. 31(a) in the same manner as the above. In order to enter “everything” which is the last word of the sentence in the created letter display unit, other pronouns (i.e., classification words to which the “everything” belongs) are searched for. In the letter display unit shown in FIG. 31(a), other pronouns exist in the 9 o'clock direction on the left side. Accordingly, the other pronoun parts are selected through the first direction input M or the second direction input P.

Consequently, as shown in FIG. 31(b), a letter display unit composed of only the other pronouns is created. The “everything” (i.e., an intended word) does not exist in the created letter display unit.

In such a case, words appearing in the letter display unit should be deleted and other words should be rearranged in the letter display unit. Accordingly, one of the center input, the rearrangement key entry, and the direction input for performing a rearrangement command is performed.

Accordingly, a letter display unit, such as that shown in FIG. 31(c), is generated. Since “everything” exists in the 9 o'clock direction on the right side in the recreated letter display unit, the “everything” is selected through the first direction input M or the second direction input P and then entered.

If an intended word does not exist in the recreated letter display unit such as that shown in FIG. 31(c), a rearrangement command can be inputted again in order to create a new letter display unit again.

Alternatively, an intended word may be directly entered in the letter entry mode out of the prediction letter entry mode. Here, a command to escape from the prediction letter entry mode can be performed by the center input in which the reference location S is pressed, a release key entry in which an additional release key (not shown) is pressed, or the direction input performed in response to movement for the reference location S. Here, in order to distinguish the command from the input for performing the rearrangement command, it is preferred that the rearrangement command be performed by one of the rearrangement key entry and the direction input performed in response to movement for the rearrangement key.

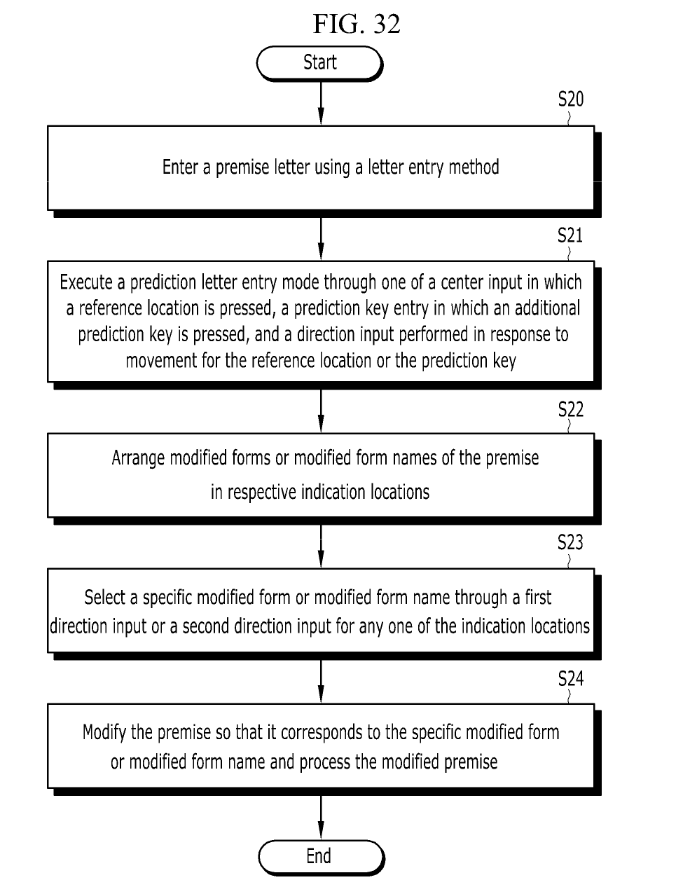

Next, a method of predicting the conversion of a premise letter and entering the premise letter in the case in which the premise letter is entered is described below with reference to FIGS. 32 to 35.

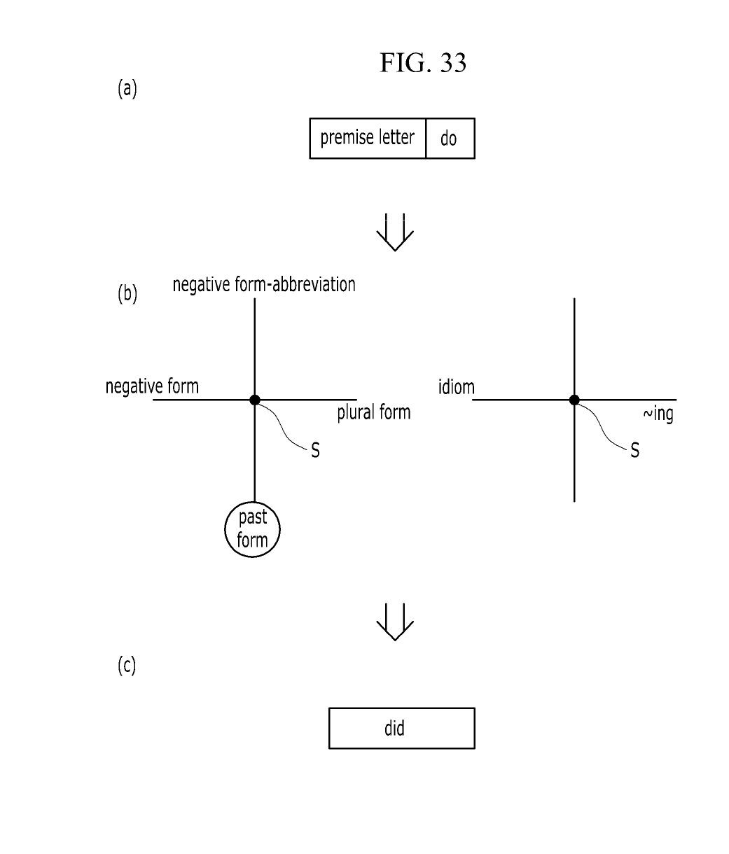

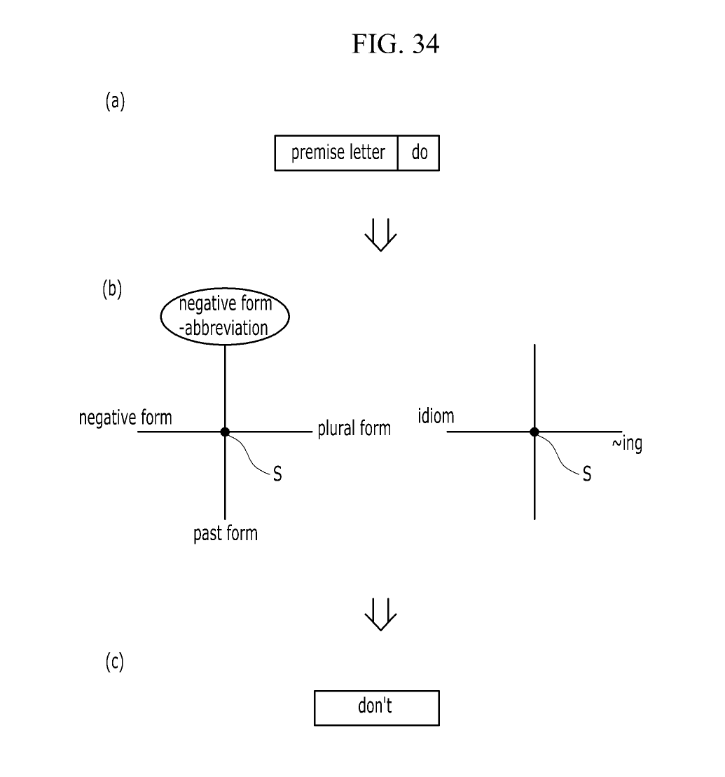

FIGS. 33 and 34 correspond to a case in which a premise letter is a word “do” and show examples in which, in the state in which the word “do” has been entered, variations for the word “do” are selected through the first direction input M or the second direction input P and then entered.

In other words, in order to switch a common letter entry mode to a prediction letter entry mode in the state in which the word “do” has been entered (step S20), one of the center input in which a reference location S is pressed, the prediction key entry in which an additional prediction key (not shown) is pressed, and the direction input performed in response to movement for the reference location S or the prediction key is performed (step S21).

However, if the premise letter has been entered in the prediction letter entry mode, the step S21 can be omitted because the prediction letter entry mode is being executed.

In the prediction letter entry mode, a variety of modified forms or modified form names for the word “do” appear in the letter display unit as shown in FIGS. 33(b) and 34(b) (step S22).

If the word “do” is sought to be converted into a past form “did” and then entered, a past form in the 6 o'clock direction on the left side is selected in the letter display unit through the first direction input M or the second direction input P (refer to FIG. 33(b)).

Further, if the word “do” is sought to be converted into “don't” an abbreviation form of negative forms and then entered, a negative form-abbreviation in the 12 o'clock direction on the left side is selected in the letter display unit through the first direction input M or the second direction input P (refer to FIG. 34(b)) (step S23).

Through such selection, the word “do” is modified to the past form “did” or the abbreviation form “don't” of the negative forms and entered (refer to FIGS. 33(c) and 34(c)) (step S24).

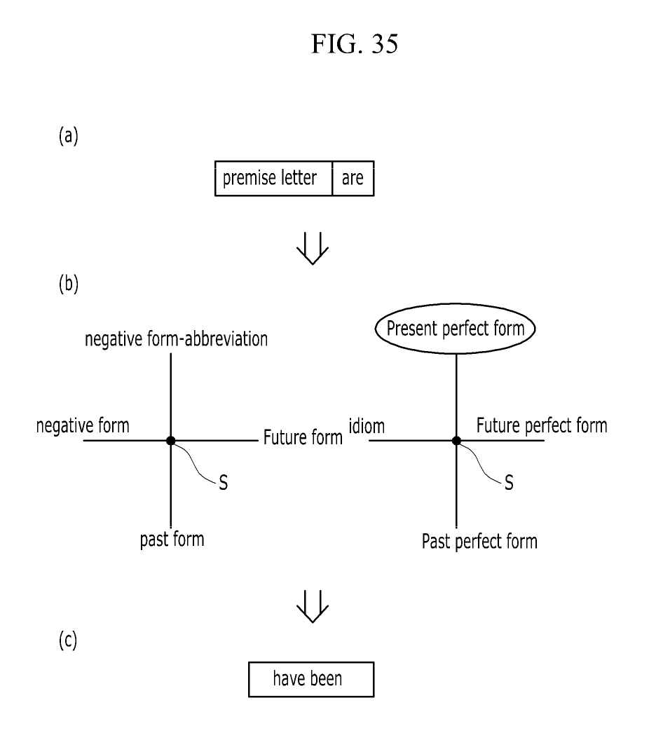

Here, a total of 6 modified forms or modified form names for the word “do” appear in the letter display unit. The number of modified forms or modified form names can be less than or more than 6 because it is determined by the number of branches in which a premise letter can be modified. That is, in the case in which a premise letter is a word “are” as in FIG. 35, a letter display unit may be composed of a total of 8 modified forms or modified form names.

Here, in order to enter “have been” which is a present perfect form for the word “are”, the present perfect form in a 21 o'clock direction on the right side of a letter display unit shown in FIG. 35(b) is selected through the first direction input M or the second direction input P. Through such selection, the word “are” is modified to “have been” and then entered.

Meanwhile, in the case in which premise letters are composed of “a,” “s”, and “a” (it is preferred that the letters be entered with one space interposed between the letters), if an idiom is selected in the letter display unit, an idiom called “as soon as” can be immediately selected through such selection and then entered.

Further, when a plural form “s” is attached in the case in which a premise letter is a noun or a singular form “s” is attached in the case in which a premise letter is a verb, if “es” should be attached to a letter at the last place of the noun or the verb, “s” or “es” is grammatically attached in order to identify the letters.

For example, in the case in which a premise letter is a noun “baby”, if a plural form of a modified form or a modified form name of the noun “baby” is selected through the first direction input M or the second direction input P, the noun “baby” is converted into “babies”.

Further, in the case in which a premise letter is a verb “watch”, when a singular form of a modified form or a modified form name of the verb “watch” is selected through the first direction input or the second direction input, the verb “watch” is converted into “watches”.

Such a conversion method is applied in the same manner when a premise letter is converted into a past form. For example, in the case in which a premise letter is a verb “stop”, when a past form of a modified form or a modified form name of the verb “stop” is selected through the first direction input M or the second direction input P, the verb “stop” is converted into “stopped”.

Meanwhile, even in the method of predicting and entering letters using the premise letters, the prediction letter entry mode may be terminated and switched to the letter entry mode by the center input in which the reference location S is pressed or the direction input performed by movement for the reference location S.

### Fourth Embodiment

Next, the fourth embodiment of the present invention is described below.

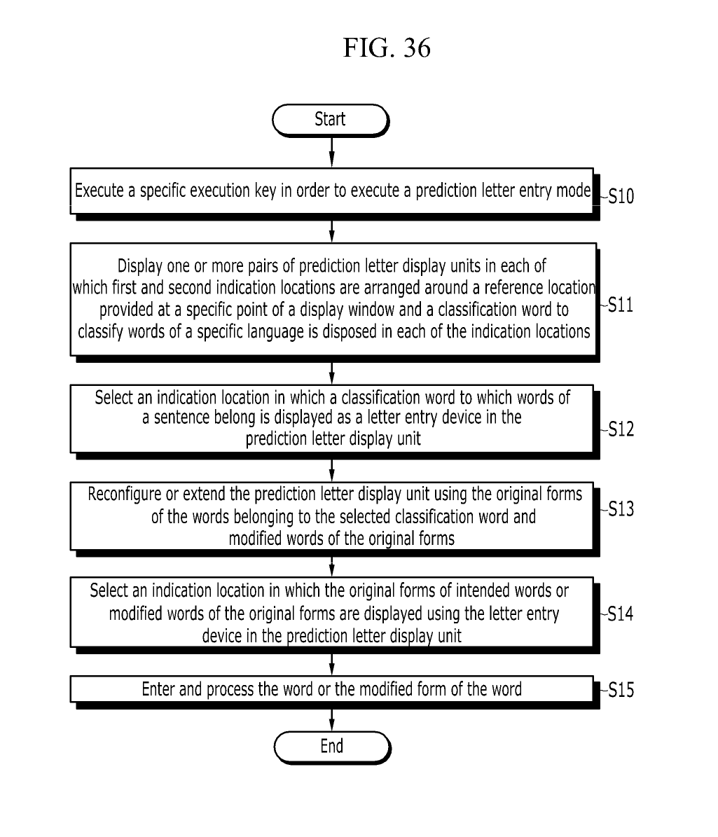

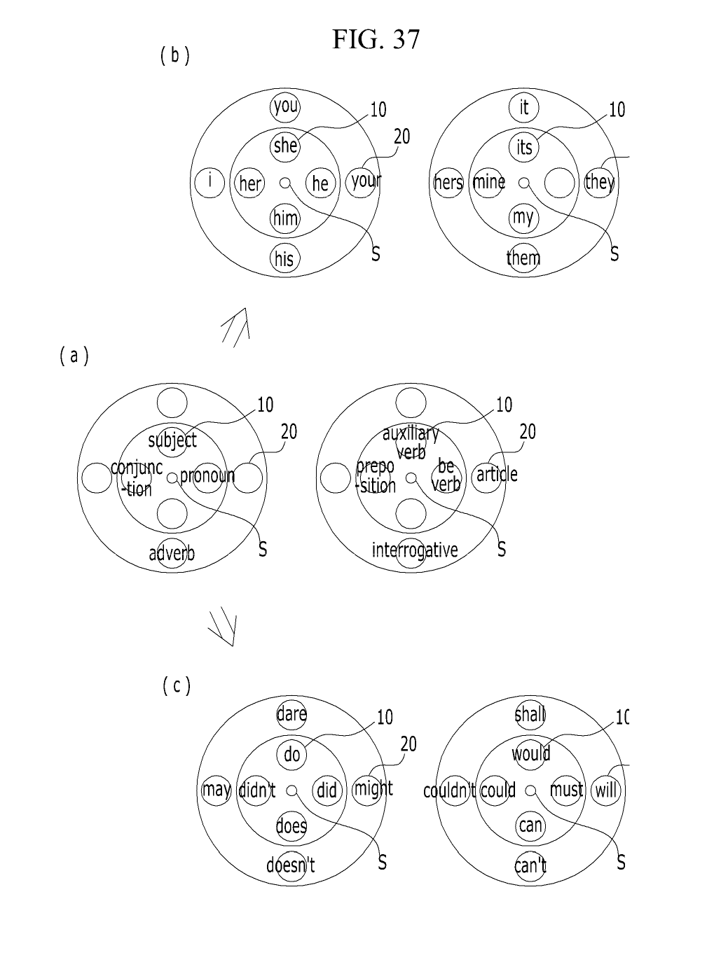

FIG. 36 is a flowchart illustrating an embodiment of the method of predicting and entering letters through a letter entry device according to the present invention, and FIG. 37 is a configuration diagram illustrating an embodiment according to the present invention.

As shown in the drawings, the method of predicting and entering letters through the letter entry device according to the present embodiment is performed by not a common letter entry mode in which letters are directly entered, but the prediction letter entry mode. To this end, a specific execution key additionally provided in the letter entry device is pressed. Alternatively, the prediction letter entry mode may have been activated at the beginning without a procedure of entering an execution key. The execution key can be any one of a function key, a shift key, and a control key in the computer keyboard. If the letter entry device is an apparatus other than a computer, a specific key in the letter entry device can be selected as the execution key (step S10).

When the prediction letter entry mode is executed, one or more pairs of prediction letter display units are displayed in the display window. In the present embodiment, two pairs of the prediction letter display units are illustrated to be displayed. However, a pair of or three pairs of the prediction letter display units may be configured according to the number of data which can be displayed in the prediction letter display units.

The prediction letter display units include a reference location S at a specific point of the display window and a plurality of first and second indication locations 10 and 20 radially disposed around the reference location S. In the present embodiment, the first and second indication locations 10 and 20 are disposed in 3, 6, 9, and 12 o'clock directions around the reference location S, indication locations close to the reference location S correspond to the first indication locations 10, and indication locations relatively distant from the reference location S correspond to the second indication locations 20.

Further, classification words classifying the words of a specific language are disposed in the first and second indication locations 10 and 20, respectively. Here, the term ‘classification word’ is used to classify the words of a specific language and can be classified according to its use in the words of the corresponding language or its location in a sentence. The classification word can have a limited number, or it is defined as a term classified according to a group depending on predetermined conditions or properties.

For example, in personal pronouns used as the subject, such as ‘I’, ‘you’, ‘he’, and ‘she’ (hereinafter referred to as ‘the subject’), pronouns except personal pronouns, such as ‘this’, ‘one’, ‘such’, and ‘everything’ (hereinafter referred to as a ‘pronoun’), auxiliary verbs such as ‘can’, ‘will’, and ‘must’, Be verbs such as ‘am’, ‘are’, and ‘is’, prepositions such as ‘in’, ‘with’, and ‘of’, and conjunctions such as ‘or’ and ‘but’, adverbs such as ‘very’, ‘much’, and ‘already’, and articles such as ‘an’, ‘a’, and ‘the’, the subject, the pronoun, the auxiliary verb, the Be verb, the preposition, the conjunction, the adverb, and the article correspond to the classification word (step S11).

In such a prediction letter display unit, the indication locations 10 and 20 displaying classification words to which an intended word belongs are selected through the letter entry device. For example, as shown in FIG. 37(a), ‘the subject’ placed in the second indication location 20 in the 12 o'clock direction on the left side of the prediction letter display unit is selected using the arrow key of a computer keyboard (step S12).

When the classification word is selected, the prediction letter display units are recomposed of the original forms of words belonging to the classification word and modified words of the original forms. That is, in the above, when ‘the subject’ is selected as the classification word, words (e.g., ‘I’, ‘he’, and ‘she’) to which ‘the subject’ belongs and modified forms (e.g., ‘my’, ‘his’, and ‘her’) of the words are displayed in the prediction letter display units, as shown in FIG. 37(b). Here, the classification words displayed in the prediction letter display units are all deleted.

Meanwhile, although only the example in which the prediction letter display units are reconfigured has been described in the present embodiment, a case in which the prediction letter display units are expanded is also possible.

FIG. 37(c) illustrates the original forms of words to which an ‘auxiliary verb’ belongs when the ‘auxiliary verb’ is selected as the classification word and modified words of the original forms (step S13).

In the reconfigured prediction letter display units, the indication locations 10 and 20, displaying the original forms of intended words and modified words of the original forms, are selected through the letter entry device (step S14).

Through such selection, the original forms of the words and the modified words of the original forms are entered (step S15). In the process of entering the words, the prediction letter entry mode may be terminated and the letter entry mode in which letters can be directly entered may be executed, by pressing an additional release key (not shown). However, the method of terminating the prediction letter entry mode can be performed through various methods, known to those having ordinary skill in the art, in addition to the pressing of a specific key, such as the release key.

Through the above prediction letter display method, a classification word can be selected and words can be immediately selected. Accordingly, an intended word can be selected accurately and easily through only two-step operations.

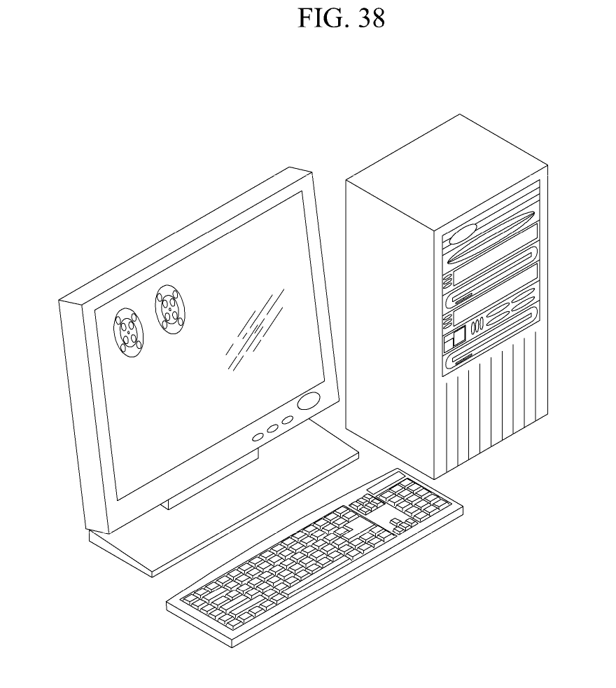

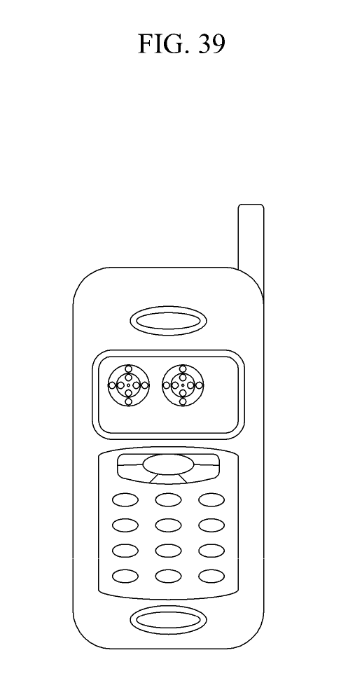

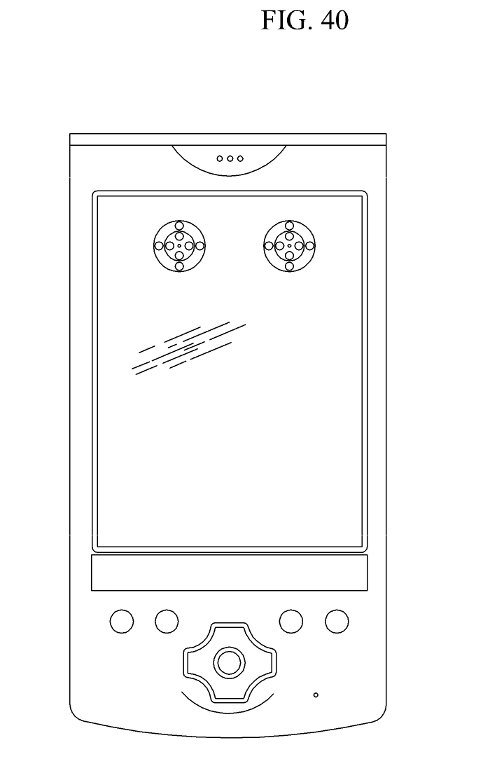

The above present invention can be implemented in various apparatuses, and FIGS. 38 to 40 show examples of the apparatuses. That is, FIG. 38 is a perspective view of a computer for implementing the method of predicting and entering letters through the letter entry device according to the present invention, FIG. 39 is a front view of a mobile phone for implementing the method of predicting and entering letters through the letter entry device according to the present invention, and FIG. 40 is a front view of a PDA for implementing the method of predicting and entering letters through the letter entry device according to the present invention.

Here, in the present invention, a keyboard such as that shown in FIG. 38, a key entry device such as that shown in 39, or a letter button displayed in a touch screen, such as that shown in FIG. 40, can be used as the letter entry device for selecting any one of the plurality of first and second indication locations 10 and 20.

Further, a monitor such as that shown in FIG. 38, a screen output device such as that shown in FIG. 39, or a screen output device such as that shown in FIG. 40 can be used as the display window in the present invention. The prediction letter display units according to the present invention are displayed in the display windows of FIGS. 38 to 40.

The computer, the mobile phone, and the PDA shown in FIGS. 38 to 40 are only examples of an apparatus for implementing the present invention, and the present invention is not implemented only in the apparatus. That is, devices other than the apparatuses shown in FIGS. 37 to 40 can be used so long as the plurality of first and second indication locations 10 and 20 can be distinguished and inputted and the inputted data can be displayed in the devices. However, unless specially mentioned in the present specification, the letter entry device of the present specification is assumed to be a computer.

Next, another embodiment of the method of predicting and entering letters through the letter entry device according to the present invention is described.

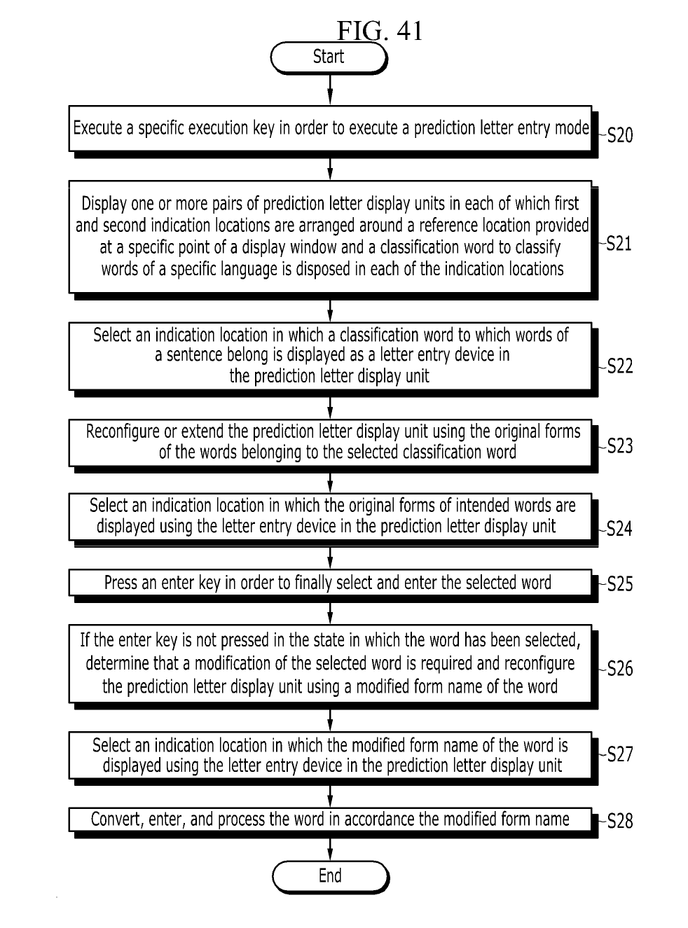

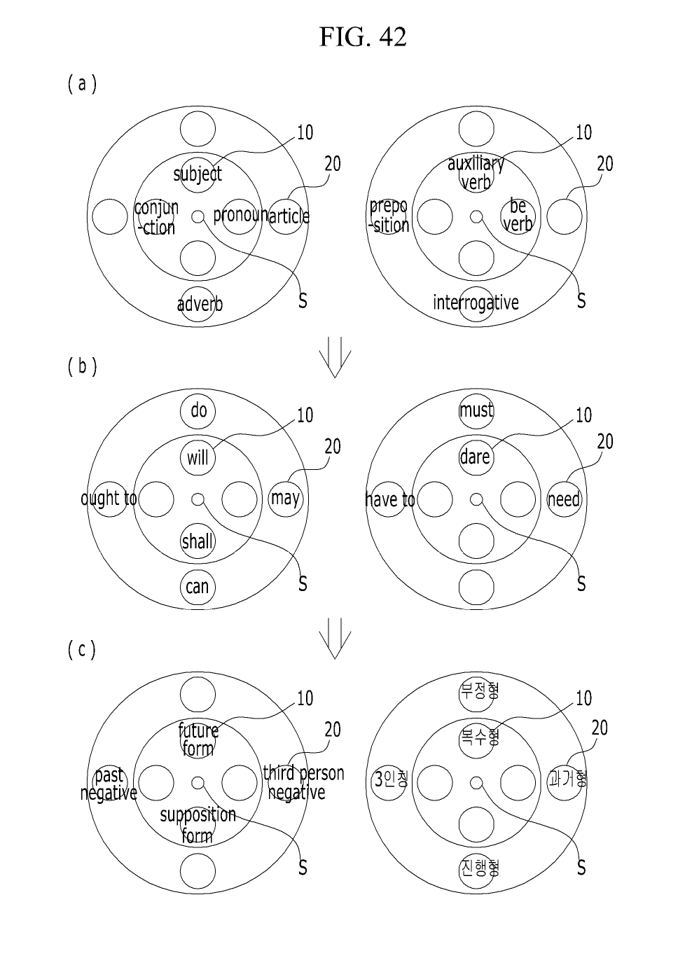

FIG. 41 is a flowchart illustrating another embodiment of the method of predicting and entering letters through the letter entry device according to the present invention, and FIG. 42 is a configuration diagram illustrating another embodiment according to the present invention.

As shown in the drawings, even in the present embodiment, in order to enter a prediction letter, first, a prediction letter entry mode is executed by pressing a specific execution key (step S20). However, the prediction letter entry mode may have been activated at the beginning without a procedure of entering the execution key.

When the prediction letter entry mode is executed, two pairs of prediction letter display units are arranged and classification words are displayed in the first and second indication locations 10 and 20 of the prediction letter display units in the same manner as the first embodiment (step S21).

In order to write a specific sentence, the indication locations 10 and 20 in which the classification words to which the respective words of the sentence belong are displayed are selected in the prediction letter display units using the letter entry device. For example, in FIG. 42(a), an ‘auxiliary verb’ placed in the first indication location 10 in the 12 o'clock direction on the left side of the prediction letter display units is selected using the letter entry device (step S22). When the classification word is selected, the prediction letter display units are reconfigured (or extended) using the original forms of words belonging to the classification word.

That is, in the case in which the ‘auxiliary verb’ is selected as the classification word in the above, the original forms (i.e., ‘do’, ‘must’, ‘may’, and ‘can’) of words belonging to the ‘auxiliary verb’ are displayed in the prediction letter display unit as shown in FIG. 42(b) (step S23).

The indication locations 10 and 20 displaying the original form of an intended word are selected from among the displayed words using the letter entry device. For example, ‘do’ can be selected from the ‘auxiliary verb’ and then entered (step S24).

Here, the selected word can actually become the intended word. In such a case, in order to finally select and enter the word, an enter key is pressed. Here, the Enter Key of a computer keyboard can become the enter key (step S25).

However, if it is necessary to modify the original form of the word, the enter key is not pressed. That is, if the enter key is not pressed in the state in which the original form of the word has been selected, it is determined that the original form of the selected word is required. Accordingly, the prediction letter display unit is reconfigured on the basis of modified form names of the word. For example, ‘the third person’, ‘a negative form’, and ‘a past form’ which are modified form names of ‘do’ are displayed in the prediction letter display unit (step S26).

In this prediction letter display unit, the indication locations 10 and 20 in which the modified form names of the word are displayed are selected using the letter entry device. For example, in the case in which a negative form of the ‘do’ is sought to be selected, the second indication location 20 in the 12 o'clock direction on the right side of the prediction letter display units in FIG. 42(c) is selected using the letter entry device (step S27).

Through such selection, the ‘do’ is modified to ‘don't’ (i.e., a negative form) and then entered (step S28).

In addition, for example, when the third person of the ‘do’ is selected, the ‘do’ is modified to ‘does’. When a progressive form of the ‘do’ is selected, the ‘do’ is modified to ‘doing’.

Next, yet another embodiment of the method of predicting and entering letters through the letter entry device according to the present invention is described below.

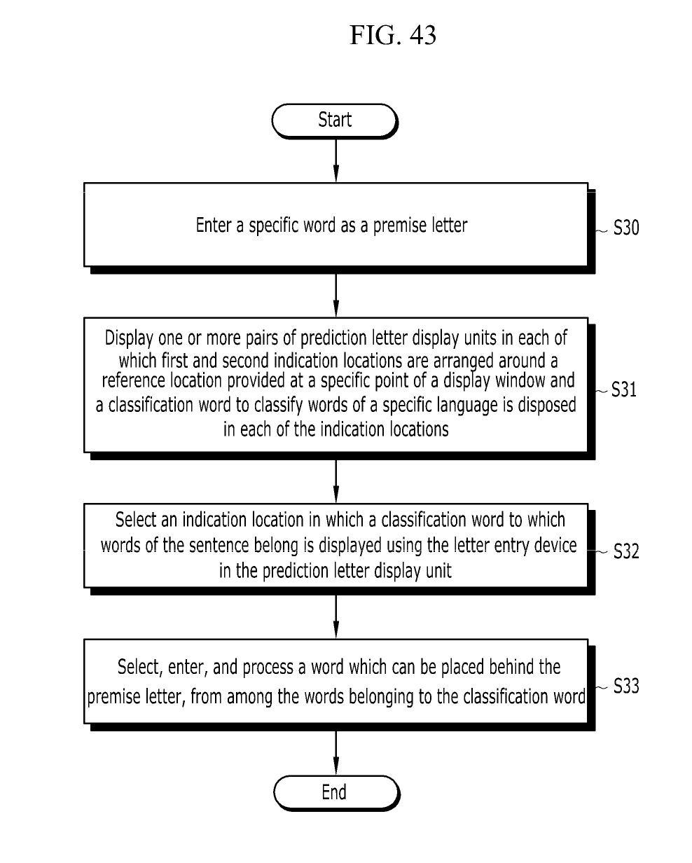

FIG. 43 is a flowchart illustrating yet another embodiment of the method of predicting and entering letters through the letter entry device according to the present invention.

The present embodiment is characterized by a method in which, when one or more words are entered in the prediction letter entry mode, the words become premise letters and, although only a classification word is entered in relation to words subsequent to the premise letters, the following words are automatically selected on the basis of the premise letters and then entered.

First, one or more words are entered through the method of predicting and entering letters, described in the above embodiment. Here, the method of entering the words can be performed using not only the method according to the above embodiment, but also a common letter entry method (step S30).

The entered words function as premise letters. That is, in the case in which words following the premise letters are limited to specific words, the specific words are entered and processed although only a classification word to which the specific words following the premise letters belong is entered.

To this end, a step of displaying the classification word in a prediction letter display unit (step S31) and a step of selecting the classification word to which the specific words belong (step S32) have to be performed. In this case, the selected classification word is converted into a specific word by the premise letters and entered (step S33).

For example, when ‘I’ (i.e., ‘the subject’) is entered using the method according to the above embodiment, ‘Be verb’ following the ‘I’ is limited to ‘am’. Accordingly, although the ‘Be verb’ (i.e., the classification word) is entered on the basis of ‘I’ (i.e., a premise letter), the ‘am’ is automatically entered and processed following the ‘I’.

Of course, in this case, ‘was’ which is the past form of the ‘am’ can be followed. In such a case, a process of checking a modified form name of the ‘am’ and additionally performing an entry has to be performed. Alternatively, the ‘am’ may be converted into ‘was’ at once by selecting a past form command of the Be verb from among modified form names.

Next, a modified example of the present embodiment is described below.

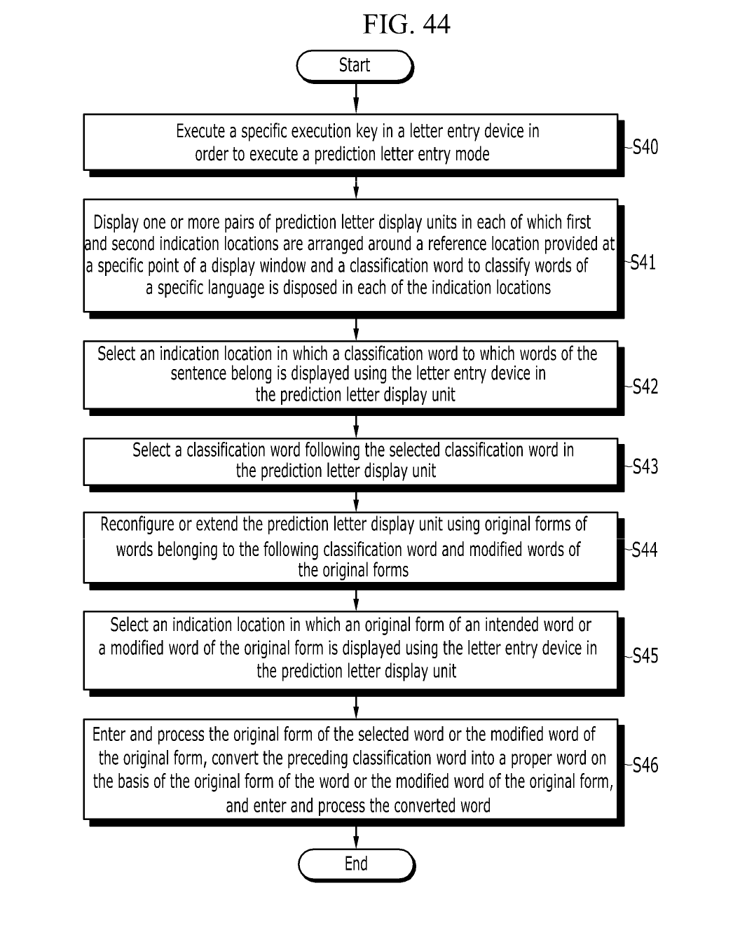

FIG. 44 is a flowchart illustrating a modified example of the embodiment.

The modified example is characterized in that in the state in which only a classification word has been entered to a word preceding a sentence (i.e., a classification standby state), following words are entered, the following words become premise words, and the preceding word is automatically selected and entered, contrary to the present embodiment.

First, in order to enter a classification word of the preceding word, the prediction letter entry mode is executed (step S40) (this step can be omitted in the case in which the prediction letter entry mode is immediately executed at the beginning). In the state in which a prediction letter display unit in which the classification word is disposed has been displayed (step S41), the indication locations 10 and 20 in which the classification word to which the preceding word belongs is displayed are selected using the letter entry device. For example, ‘Be verb’ is selected in the prediction letter display unit shown in FIG. 37(a) (step S42).

Next, a classification word following the selected classification word is selected in the prediction letter display unit. For example, ‘the subject’ can be selected as the classification word (step S43). In this case, the prediction letter display unit is reconfigured on the basis of the original form of a word to which ‘the subject’ belongs or a modified word of the original form, as shown in FIG. 37(b) (step S44).

When the original form of an intended word or a modified word of the original form is selected in the reconfigured prediction letter display unit (step S45), the selected preceding classification word is converted into a proper word on the basis of the selected original form or the modified word of the original form and then entered (step S46). For example, when a word ‘I’ is selected, Am’ can be followed as a word preceding the ‘I’. Accordingly, the ‘Be verb’ is converted into ‘Am’ using the ‘I’ as a premise word.

Next, further yet another modified example of the present embodiment according to the present invention is described.

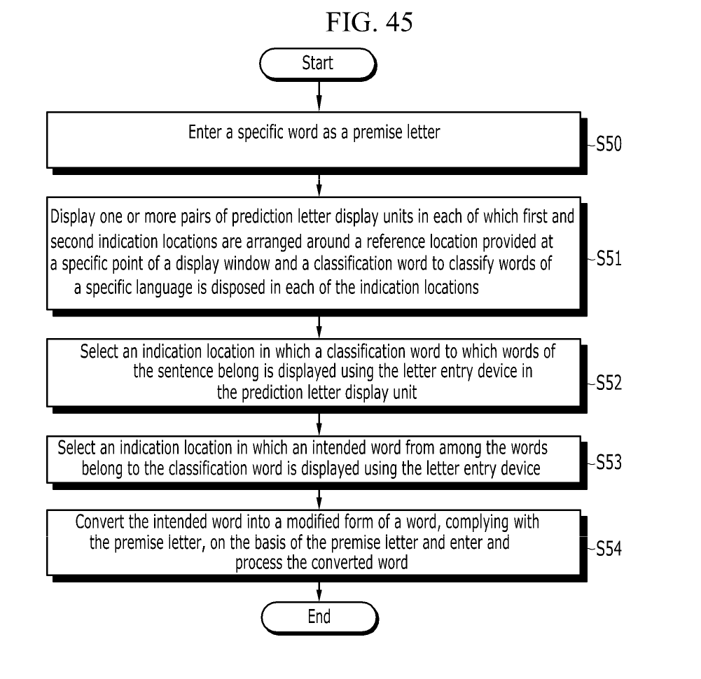

FIG. 45 is a flowchart illustrating another modified example of the embodiment.

The present modified example is characterized in that the original form of a following word is converted into a proper form on the basis of a premise letter which is a preceding word.

To this end, in the same manner as the present embodiment, a premise letter which is a preceding word is entered (step S50). Next, a process of entering a following word is performed. As described above, a step of displaying a prediction letter display unit in which a classification word is disposed (step S51), a step of selecting the classification word (step S52), and a step of selecting the indication locations 10 and 20 in each of which an intended word from among words belonging to the classification word is displayed using the letter entry device (step S53) are performed. In this case, the intended words are converted into modified forms, grammatically complying with the premise letter, on the basis of the premise letter and then entered (step S54).

For example, first, ‘She’ (i.e., the subject) is entered as a premise letter, and an ‘auxiliary verb’ (i.e., a classification word to which following words belong) is selected. Next, ‘do’ is selected from the ‘auxiliary verb’. In this case, the ‘do’ is converted into ‘does’ which grammatically complies with ‘She’ (i.e., the premise letter).

In this case, if it is sought to select ‘did’ as a modified form of the ‘do’, the modified form of the ‘do’ can be additionally selected and then entered after the ‘do’ is selected.

As a similar example, in order to use ‘She’ as a premise letter and enter a following word, when ‘Be verb’ is selected as a classification word and ‘Be verb past’ which is a modified form of the ‘Be verb’ is selected, ‘was’ is immediately entered and processed as a word following ‘She’ (i.e., the premise letter).

Further, in the case in which there is no limit to space as in a touch screen, not only the indication locations 10 and 20 for selecting the classification words (i.e., the subject, an auxiliary verb, Be verb, etc.), but also the indication locations 10 and 20 for selecting modifications thereof (i.e., past negative, a third person negative) can be all arranged. In such a case, a following word may be selected at once.

For example, when an ‘auxiliary verb do’ is immediately selected in the state in which ‘She’ has been selected as a premise letter, the ‘auxiliary verb do’ is entered and processed as ‘does’ on the basis of ‘She’ (i.e., the premise letter). Further, when ‘Be verb past’ is immediately selected in the state in which ‘She’ has been selected as a premise letter, the ‘Be verb past’ is entered and processed as ‘was’ on the basis of ‘She’ (i.e., the premise letter). Furthermore, when ‘do the third person negative’ is immediately selected in the state in which ‘She’ has been selected as a premise letter, the ‘do the third person negative’ is entered and processed as ‘doesn't’ on the basis of ‘She’ (i.e., the premise letter).

It is preferred that instead of displaying all the indication locations 10 and 20 for selecting a classification word and the indication locations 10 and 20 for selecting the modifications in the display window, only the indication locations 10 and 20 for selecting a classification word with which following words can be combined according to the form of a selected premise letter and modifications of a word belonging to the classification word be arranged.

Next, yet another embodiment according to the present invention is described.

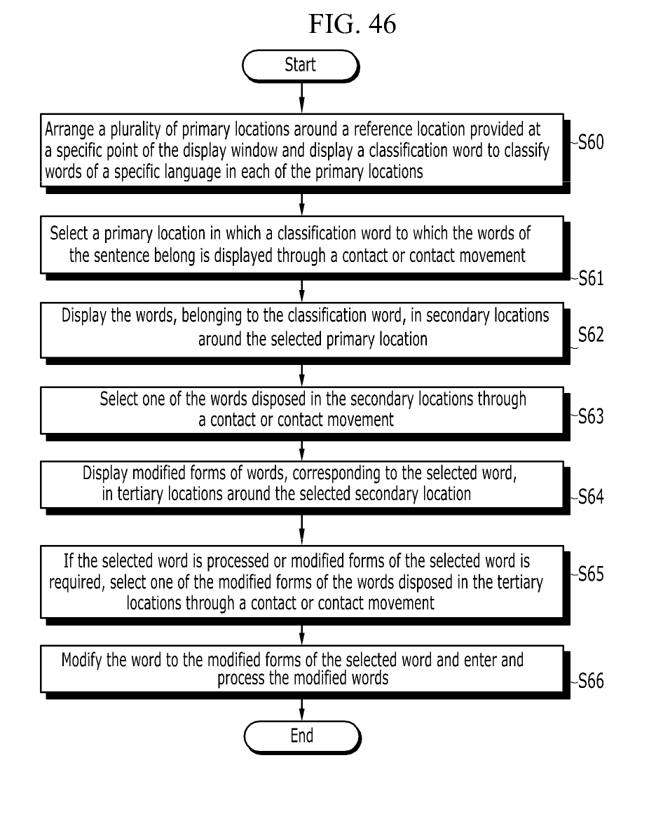

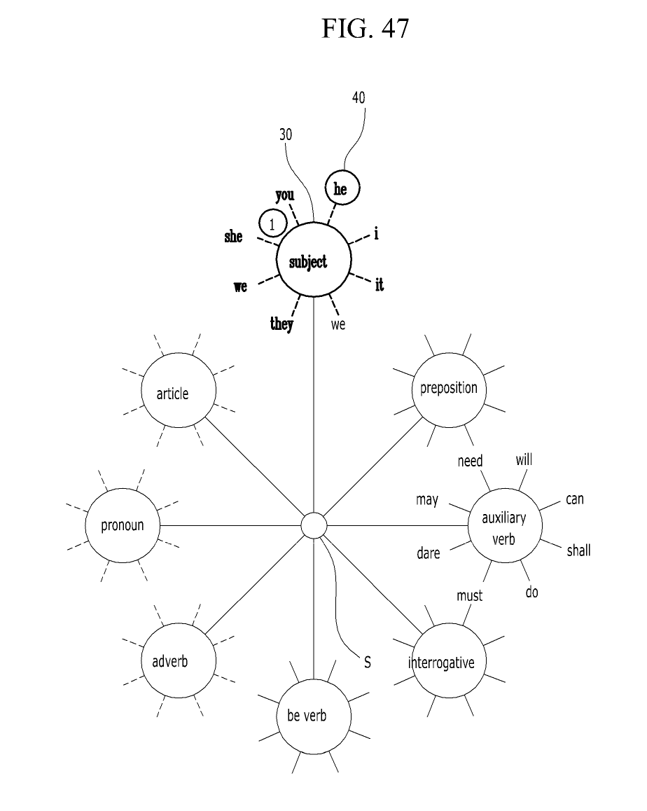

FIG. 46 is a flowchart illustrating yet another embodiment according to the present invention, and FIGS. 47 to 53 are configuration diagrams illustrating the embodiment described with reference to FIG. 46.

In the present embodiment, a touch screen is used as the letter entry device. In other words, a touch screen configured to receive data corresponding to a contact point in a display window or contact movement for the contact point in response to a contact or contact movement for the display window and to display the received data in the display window is used as the letter entry device.

Further, the present embodiment is characterized in that a touch screen is used as the letter entry device and entries for the touch screen can be performed through a contact or contact movement so that prediction letter display units can be consecutively extended and arranged and a sentence can be completed by entering words according to an arrangement order or without limit to an arrangement order.

In addition, in the present embodiment, all the characteristics in the three embodiments can be implemented.

Furthermore, the present embodiment is characterized in that, when primary locations in which respective classification words are displayed are selected, secondary locations are extended around each of the primary locations and then displayed and, when one of the secondary locations is selected, tertiary locations around each of the secondary locations are sequentially extended and displayed.

The present embodiment is described in more detail. As shown in FIG. 47, a plurality of primary locations 30 is radially arranged around a reference location S provided at a specific point of the display window, and a classification word to classify the words of a specific language is displayed in each of the primary locations 30 (step S60).

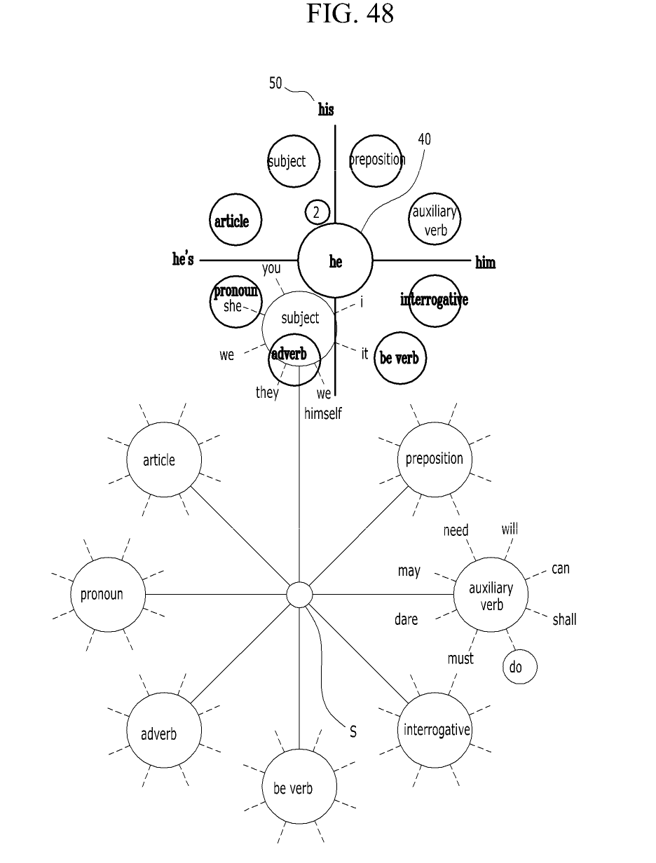

Here, in order to write a sentence composed of the language, the primary location 30 in which the classification word to which the words of the sentence belong is displayed is selected through a contact or contact movement (step S61). In response thereto, a secondary location 40 around the selected primary location 30 is activated, and words belonging to the classification word are displayed in the secondary location 40. That is, as shown in FIG. 48, when ‘the subject’ is selected from the classification words, words, such as he and she, are arranged in the secondary location 40 around ‘the subject’.

It is also preferred that although ‘the subject’ is selected from the classification words and the secondary location 40 around ‘the subject’ is activated, classification words other than ‘the subject’ be displayed in the display window. This is because, after an entry through a selected classification word is performed, another classification word can be immediately selected and a next word can be consecutively entered (step S62).

Next, when one of the arranged words is selected through a contact or contact movement (step S63), a tertiary location 50 around the selected secondary location 40 is activated. Modified forms corresponding to the word are displayed in the tertiary location 50. That is, when ‘he’ is selected from ‘the subject’, the modified forms (e.g., his and him) of the ‘he’ are activated in the tertiary location 50.

In this state, the selected secondary location 40 becomes a reference location S for the primary locations 30 around the selected secondary location 40, and thus a classification word corresponding to the first reference location S is distinguished from the modified form of a word corresponding to the tertiary location 50 and then displayed.

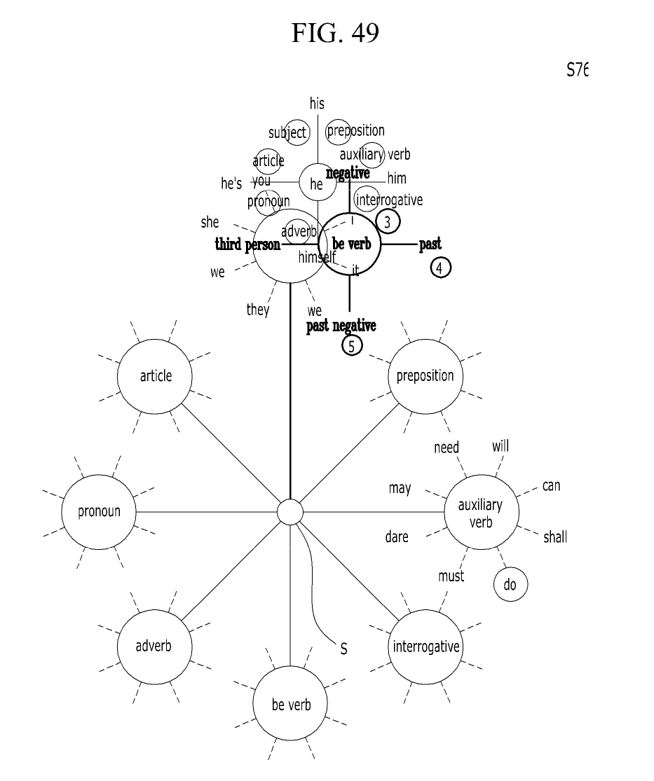

That is, as shown in FIG. 49, classification words are displayed around the secondary location 40 corresponding to ‘he’ (i.e., a selected word) using the secondary location 40 as the reference location S. It is preferred that the primary locations 30 in which the classification words are displayed be distinguished from the tertiary locations 50 and then displayed because the tertiary locations 50 are arranged around the ‘he’, (step S64).

Further, in this case, although the selected word can be entered without further selecting the modified forms of the selected word, the form of the selected word may need to be converted. In such a case, one of the modified forms of the word disposed in the tertiary location 50 is selected through a contact or contact movement (step S65).

The word is modified to a modified form of the word selected through the above process and then entered (step S66).

A method of entering a sentence according to the present embodiment is described as an example.

If ‘He is’ is sought to be entered, ‘the subject’ is first selected in the primary locations 30 (\textcircled{1} of FIG. 47). When ‘the subject’ is selected, ‘He’ is selected in the extended secondary locations 40 (\textcircled{2} in FIG. 48). In the state in which the ‘He’ has been selected, ‘Be verb’ is selected in the primary locations 30 in which activated classification words are displayed (\textcircled{3} in FIG. 49). In response thereto, the ‘He’ becomes a premise letter, and thus ‘is’ of the ‘Be verb’ is automatically selected and entered as a following word.

Here, in the case in which a sentence to be entered is ‘He was’, ‘a past form’ is selected in a modified form name of the ‘Be verb’ is selected after the \textcircled{3} (\textcircled{4} in FIG. 49).

Further, in the case in which a sentence to be entered is ‘He wasn't’, a ‘negative past form’ is selected in the modified form name of the ‘Be verb’ after the \textcircled{3} (\textcircled{5} in FIG. 49).

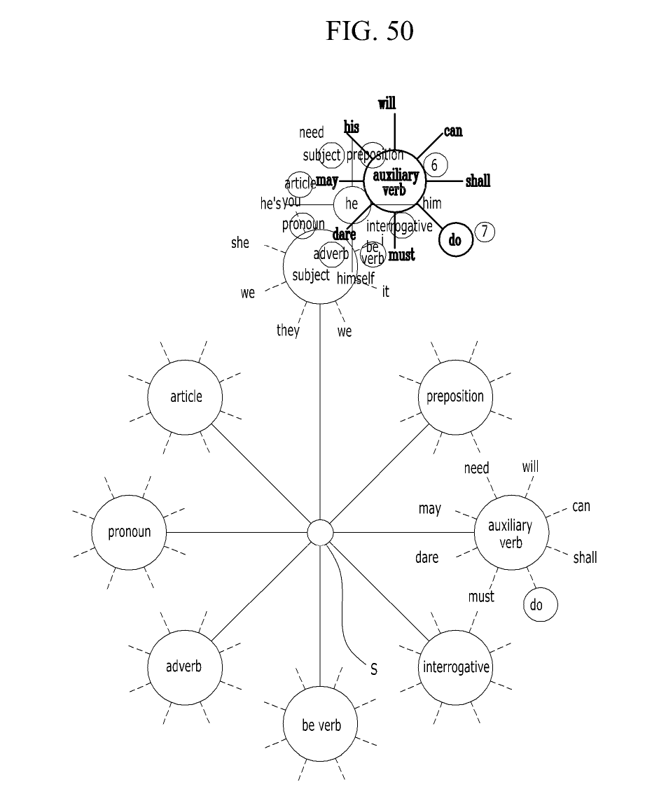

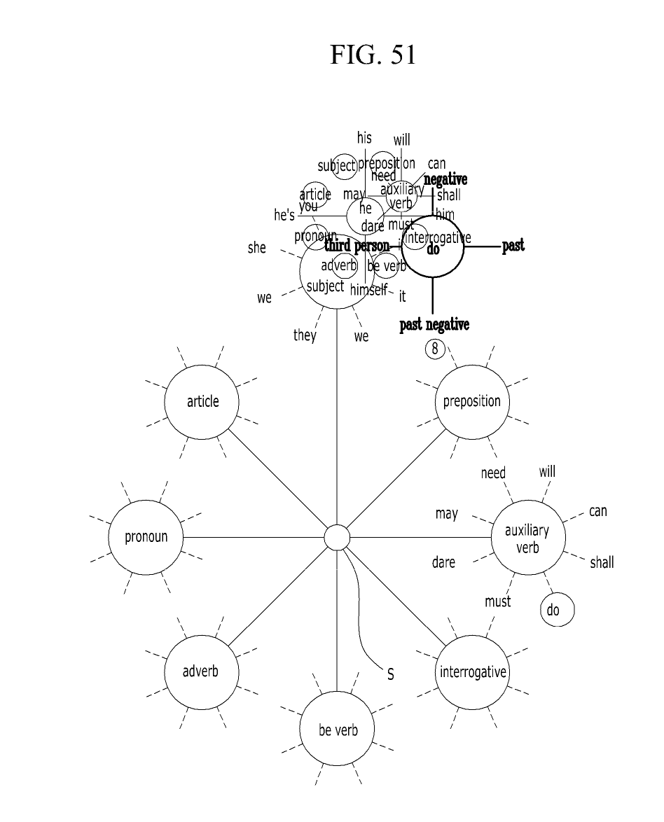

Meanwhile, in the case in which a sentence to be entered is ‘He doesn't’, an ‘auxiliary verb’ is selected in the primary location 30 in which an activated classification word is displayed in the state in which the ‘He’ has been selected after the \textcircled{2} (\textcircled{6} in FIG. 50). When the ‘auxiliary verb’ is selected, words belonging to the ‘auxiliary verb’ are arranged around the ‘auxiliary verb’ in the secondary location 40. Here, ‘do’ is selected from among the arranged words (\textcircled{7} in FIG. 50). When ‘past negative’ of the tertiary location 50 appearing as the modified form of the ‘do’ is selected through such selection (\textcircled{8} in FIG. 51), ‘doesn't’ is entered, thereby completing the sentence.

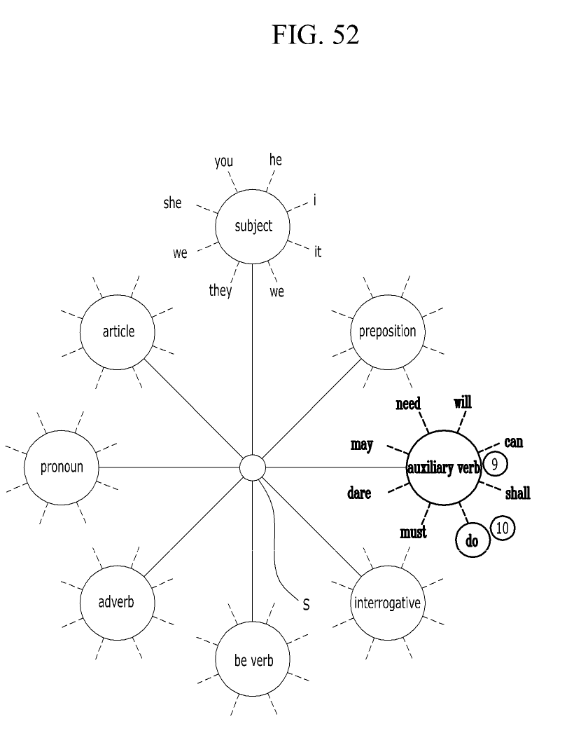

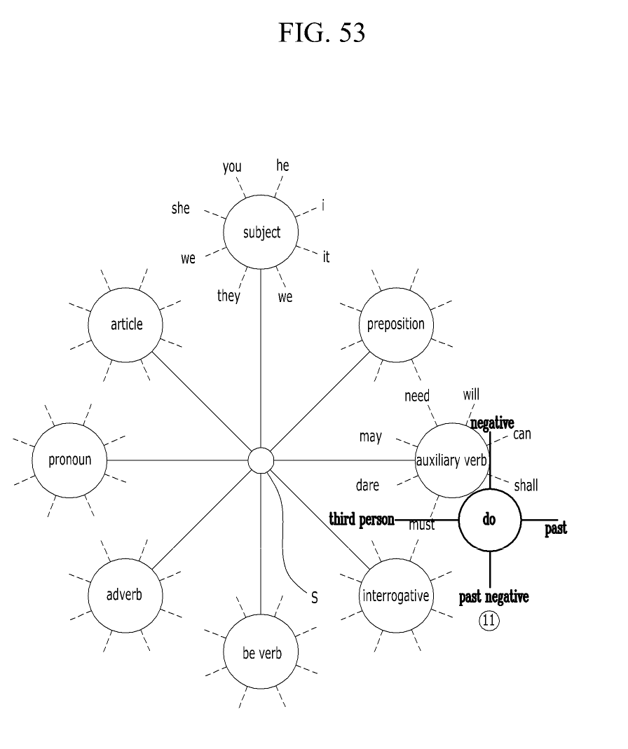

However, ‘He doesn't’ (i.e., the sentence) may be entered using another method. In other words, in the state in which the ‘He’ has been entered (\textcircled{2}), the primary location 30 in which an ‘auxiliary verb’ is displayed is selected from among the primary locations 30 (\textcircled{9} in FIG. 52). Next, as in the above, when the ‘auxiliary verb’ is selected, words belonging to the ‘auxiliary verb’ are arranged around the ‘auxiliary verb’ in the secondary location 40. Next, ‘do’ is selected from among the arranged words (\textcircled{10} in FIG. 52). When ‘past negative’ of the tertiary location 50 appearing as the modified form of the ‘do’ is selected through such selection (\textcircled{11} in FIG. 53), ‘doesn't’ is entered. A sentence can be produced by consecutively entering words using the above method as described above.

Next, a modified example of the present embodiment is described.

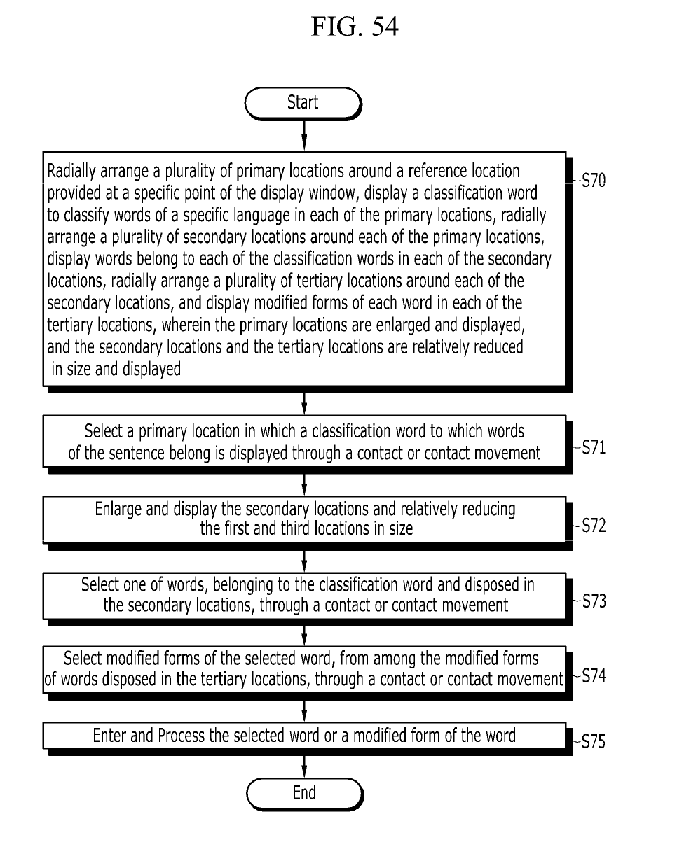

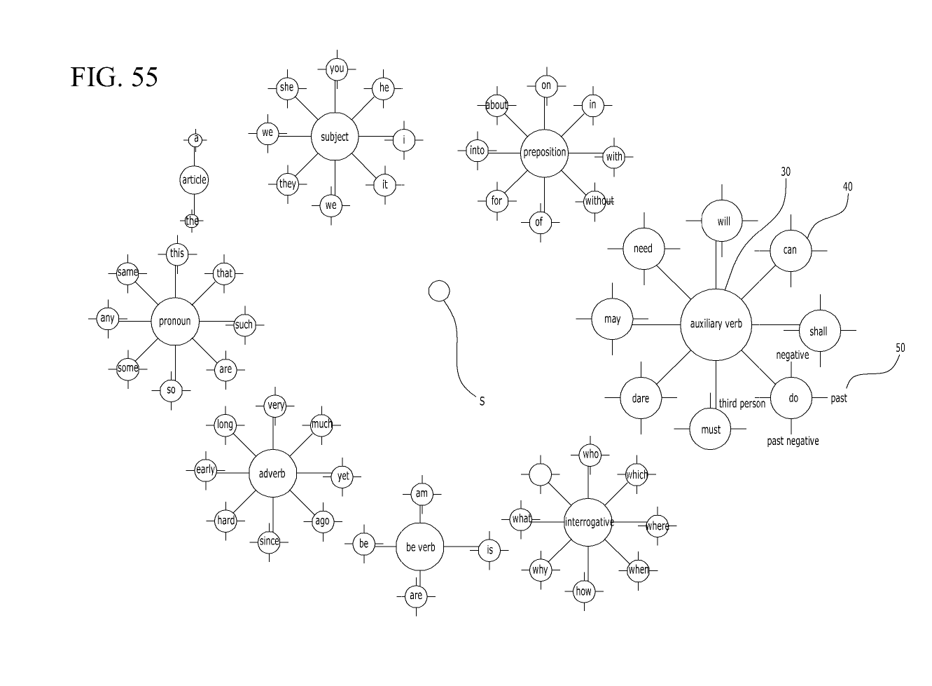

FIG. 54 is a flowchart illustrating a modified example of the embodiment described with reference to FIG. 46, and FIGS. 55 to 57 are configuration diagrams illustrating the modified example described with reference to FIG. 54. Here, in FIGS. 55 to 57, some of words, respectively corresponding to secondary locations and tertiary locations, and some of modification forms of the words are not illustrated. However, this is only for simplicity of the drawings, and it is to be understood that all the words and modification forms are actually represented.

The present modified example is characterized in that a prediction word is entered in the same manner as the present embodiment, but all classification words, words, and modified forms thereof are initially displayed in the display window and the sizes of a primary location, secondary locations, and tertiary locations are changed when the locations are selected.

More particularly, as shown in FIG. 55, a plurality of primary locations 30 are radially arranged around a reference location S provided at a specific point of the display window, and classification words classifying the words of a specific language are displayed in the respective primary locations 30. Further, a plurality of secondary locations 40 is radially arranged around each of the primary locations 30, and words belonging to each of classification words are displayed in each of the secondary locations 40. Further, a plurality of tertiary location 50 is radially arranged around each of the secondary locations 40, and the modified forms of each word are displayed in the respective tertiary locations 50 (step S70).

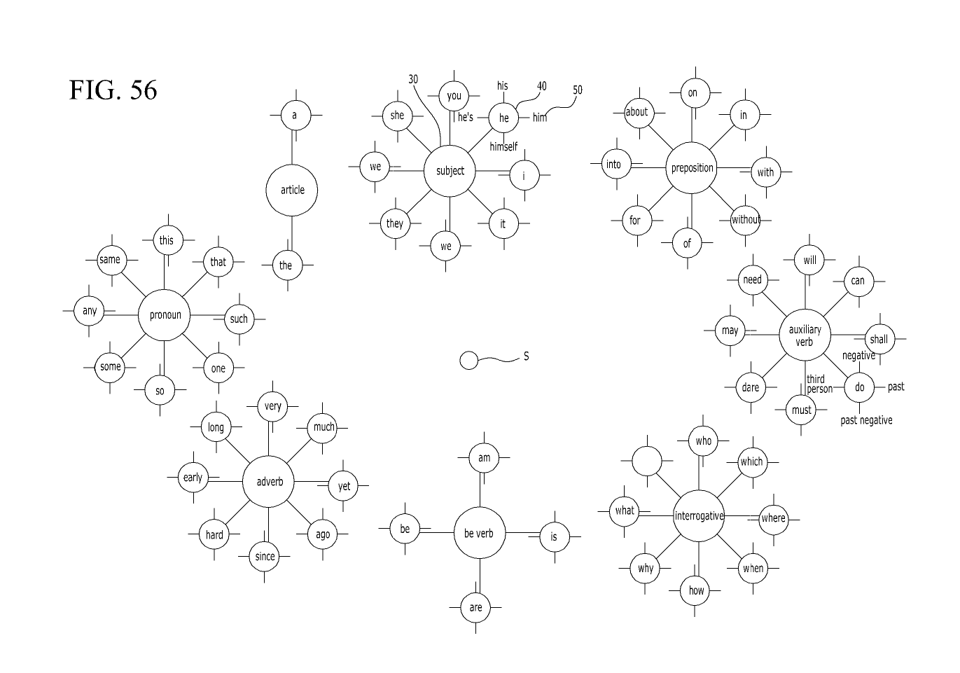

Here, one of the primary locations 30 in which a specific classification word is displayed is selected through a contact or contact movement (step S71). When the primary location 30 is selected, the secondary locations 40 in which respective words are disposed around the selected classification word is enlarged and displayed, and the primary locations 30 and the tertiary locations 50 are displayed relatively small. That is, as shown in FIG. 56, when an ‘auxiliary verb’ is selected in the primary locations 30, the secondary locations 40 around the ‘auxiliary verb’ are enlarged and displayed (step S72).

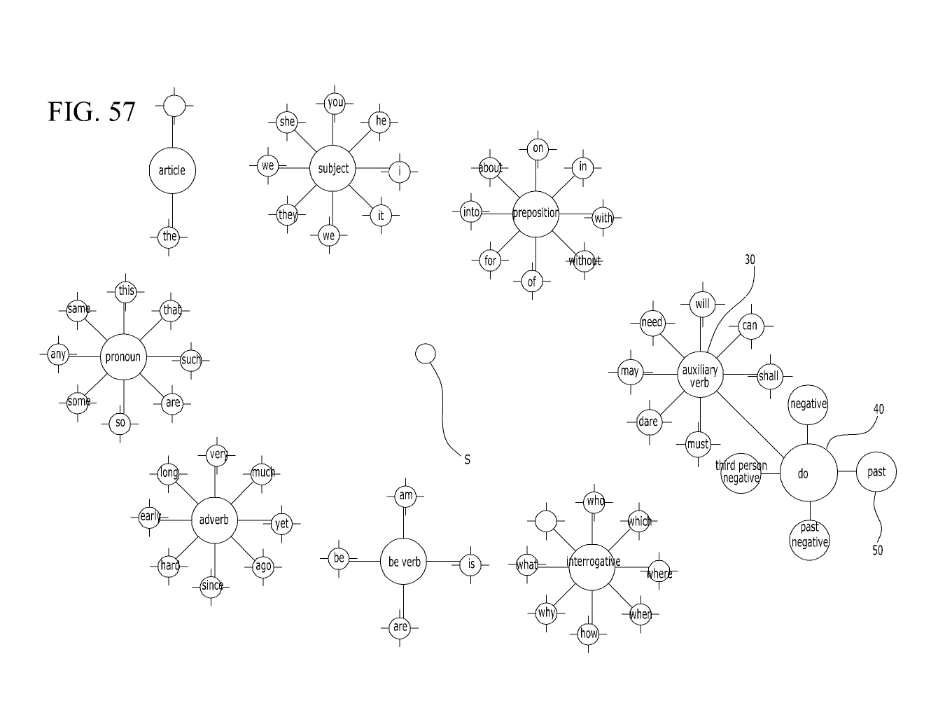

Next, one of words, belonging to the classification word and disposed in the secondary locations 40, is selected through a contact or contact movement (step S73). When the word is selected as described above, the tertiary locations 50 in which the modified forms of the word are disposed around the selected word are enlarged and displayed as in the above, and the primary locations 30 and the secondary location 40 are displayed relatively small. That is, as shown in FIG. 57, when ‘do’ is selected in the secondary locations 40, the tertiary locations 50 around the ‘do’ are enlarged and displayed (step S74).

Here, the modified forms of the selected word, from among the modified forms of the words disposed in the enlarged and displayed tertiary locations 50, are selected through a contact or contact movement (step S75).

Through the process, the entry of the selected word or the modified forms of the words is processed (step S76).

Next, another modified example of the embodiment according to the present invention is described.

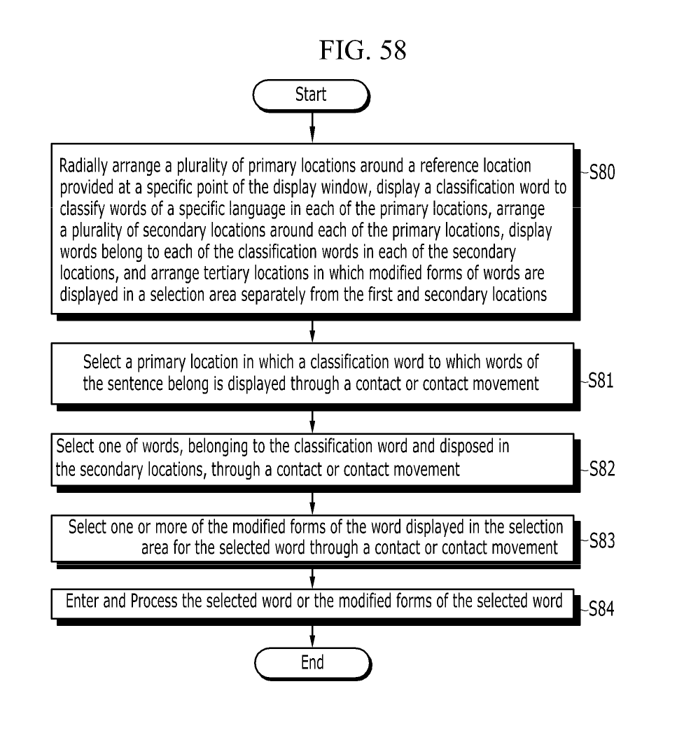

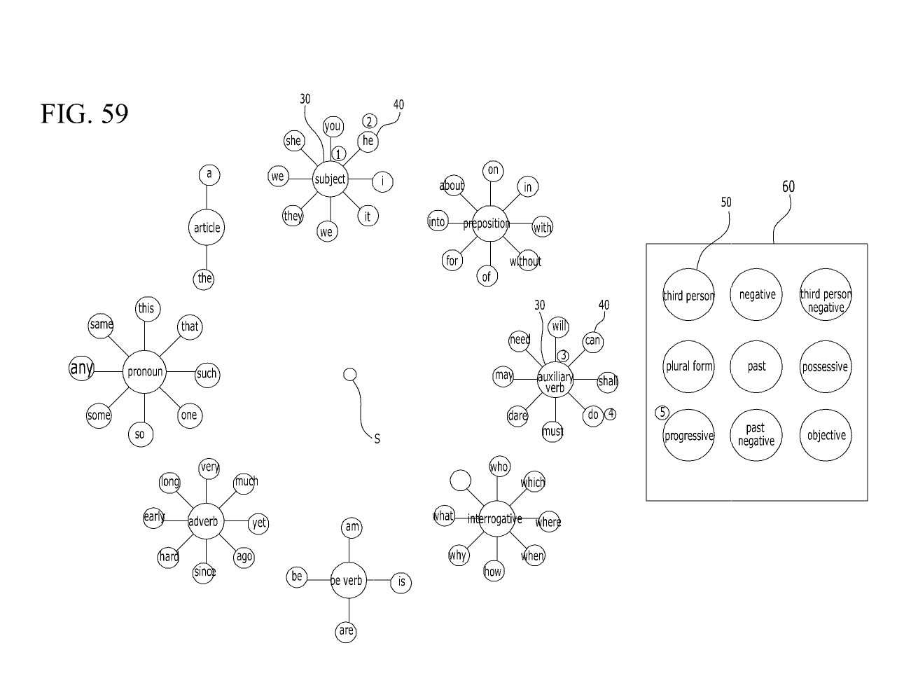

FIG. 58 is a flowchart illustrating another modified example of the embodiment described with reference to FIG. 46, and FIG. 59 is a configuration diagram illustrating the modified example described with reference to FIG. 58.

The present modified example is characterized in that primary locations 30 in which respective classification words are displayed and secondary locations 40 in which respective words belonging to each of the classification words are displayed, and modified forms of the words are displayed in each of the tertiary locations 50 disposed in an additional selection area 60 of the display window.

More particularly, as shown in FIG. 59, the primary locations 30 in which the respective classification words are displayed and the secondary locations 40 disposed around each of the primary locations 30 are disposed in the display window. Here, words belonging to each of the classification words are displayed in the respective secondary locations 40 as in the above. Further, unlike the above, the tertiary locations 50 in which modified forms of a word are displayed are disposed in the selection area 60 of the display window (step S80).

Accordingly, in order to enter a word, first, the primary location 30 in which a classification word to which a corresponding word belongs is displayed is selected through a contact or contact movement (step S81). One of words, belonging to the classification word and disposed in the respective secondary locations 40, is selected through a contact or contact movement (step S82).

Next, in the selection area 60, the tertiary location 50 corresponding to one of modified forms displayed in the selection area 60 is selected (step S83). Accordingly, the selected word or the modified form of a word is entered and processed (step S84).

For example, if it is sought to enter ‘He doing’, the primary location 30 in which ‘the subject’ is displayed is first selected as shown in FIG. 59 (\textcircled{1}). Next, the secondary location 40 in which ‘He’ (i.e., a word belonging to ‘the subject’) is displayed is selected (\textcircled{2}). Next, in order to enter ‘doing’, the primary location 30 in which an ‘auxiliary verb’ is displayed is selected (\textcircled{3}), and the secondary location 40 in which ‘do’ is displayed is selected in the ‘auxiliary verb’ (\textcircled{4}). Next, in the selection area 60, ‘doing’ is entered by selecting the tertiary location 50 in which ‘progress’ is displayed (\textcircled{5}). Accordingly, ‘He doing’ is completed.

However, after the word of the secondary location is first selected without selecting a classification word in the primary location, letters can be entered by selecting a modified form of the word in the tertiary location. Further, after a modified form of a word is first selected in the tertiary location, letters may be entered by selecting a word to be modified in the secondary location.

Meanwhile, unlike the above-described embodiments, a method may be used in which, when a premise letter ‘d’ is entered in order to select an auxiliary verb ‘doing’, a parts-of-speech category including auxiliary verbs is displayed and ‘doing’ is selected from among the auxiliary verbs including ‘d’ by selecting one of the auxiliary verbs.

Here, the parts-of-speech category may be converted into a category, such as a synonym or an equivalent.

Further, only the parts-of-speech and form categories, such as a past form, a progressive form, and the third person, are not represented, but words in itself, such as ‘did’, ‘doing’, and ‘does’ may be represented and the words may be selected.

### Fifth Embodiment

Next, a fifth embodiment of the present invention is described below.

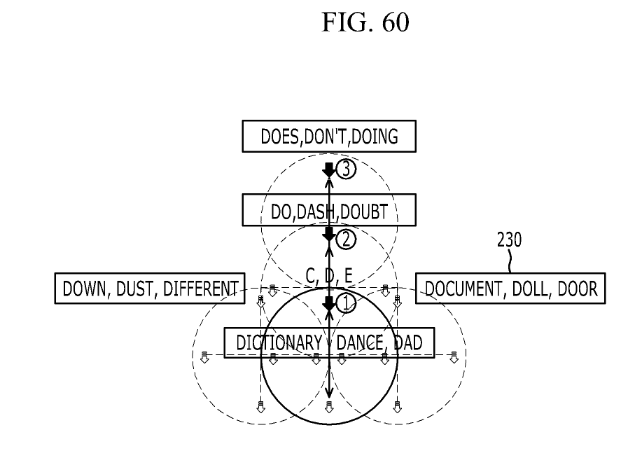

The present embodiment relates to an entry through the activation of a prediction word. FIG. 60 shows a method of a user conveniently entering data through the activation of a prediction word using a keypad.

More particularly, when movement is performed upwardly from a reference location P, D of a predetermined keypad is entered. When 2 or 4 words are radially arranged using the D as a reference location, 8 to 16 words can be selected. In this case, it is preferred that the words be arranged on the basis of words of high frequency.

In the drawing, a case in which sets of words, each including 3 words, are radially arranged is illustrated. That is, when an upward direction is selected in second direction indication locations, a movement entry (i.e., second input means) is performed and a letter D is selected (\textcircled{1}). Accordingly, English words starting from the letter D are radially displayed in the keypad display unit. Accordingly, when a user further performs any one of first to third entry means (i.e., when the user performs an upward pressing entry operation in FIG. 60) (\textcircled{2}), an English word DO is selected. If a verb, such as DO, is selected, a progressive form, a past form, or a comparison form thereof can be selected. In the case of a noun, words that can be selected can be extended so that synonyms or equivalents of the words can be further selected. That is, when an upward movement entry operation is performed (\textcircled{3}) after the entry operation \textcircled{2} is performed, a word DON'T can be selected. When an upward pressing operation is performed (\textcircled{3}), DOES can be entered.

In this case, it is preferred that a user previously set words of high frequency in order to maximize user convenience.

Although not shown, the present invention can also be applied when Korean text is entered in a similar way, in addition to the English alphabet.

In the above-described embodiments, an automatic postposition completion function can be further executed. That is, a postposition suitable for an entered word may be automatically attached, thereby completing an entry.

Further, in each of the embodiments, an automatic erroneous entry correction function may be further executed. That is, although letters are entered out of order, the closest correct word capable of completing the entered letters can be searched for and displayed.

Furthermore, the above letter entry devices and methods and the above prediction methods do not depend on any one of them, but can be independently performed.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

1. A method of predicting and entering a word, the method comprising the steps of:
entering a premise letter through one or more direction inputs from among a contact, pressing, movement, and an inclination for indication locations radially arranged around a reference location and spaced apart from one another;
switching to a prediction word entry mode in response to a set input and arranging prediction words, including the premise letter, in the indication locations; and
selecting an intended word from among the prediction words through the direction input and entering the selected word.

2. The method of claim 1, wherein the premise letter comprises first 3 or less letters of the intended word.

3. The method of claim 1, wherein the direction inputs according to the contact, the pressing, the movement, and the inclination are assigned different letters.

4. The method of claim 1, wherein in the prediction word selection step, the prediction words are selected through a combination of two or more input operations of the direction inputs.

5. The method of claim 1, wherein the prediction word selection step comprises the steps of:
rearranging derivative words of a prediction word selected by performing any one of the direction inputs; and
selecting the intended word from among the rearranged derivative words through the direction input.

6. The method of claim 1, wherein the switch of the prediction word entry mode is performed by a center input for the reference location or an input using an additional key.

7. The method of claim 1, wherein the switch of the prediction word entry mode is performed by consecutively performing two or more input operations of the direction inputs, including the direction inputs for the entry of the premise letter.

8. The method of claim 1, wherein the switch of the prediction word entry mode is performed by any one of the direction inputs.

9. The method of claim 1, wherein the indication locations comprise:
a plurality of first indication locations radially arranged around the reference location and spaced apart from one another; and
a plurality of second indication locations radially arranged around each of the first indication locations and spaced apart from one another,
wherein different letters are assigned to respective direction inputs for the first indication locations and the second indication locations.

10. An electronic device in which a method of predicting and entering a word according to 9 claim 1 is implemented.

11. A method of predicting and entering letters through a letter entry device, the method comprising the steps of:
displaying one or more pairs of prediction letter display units in each of which first and second indication locations are arranged around a reference location provided at a specific point of a display window and a classification word to classify words of a specific language is disposed in each of the indication locations;
selecting an indication location in which a classification word to which words of a sentence belong is displayed using the letter entry device in the prediction letter display unit;
reconfiguring or extending the prediction letter display unit using original forms of words belonging to the selected classification word and modified words of the original forms;
selecting an indication location in which an original form of an intended word or a modified word of the original form is displayed using the letter entry device in the prediction letter display unit; and
entering and processing the word or the modified form of the word.

12. The method of claim 11, further comprising the step of pressing a specific execution key in the letter entry device in order to execute a prediction letter entry mode, before the step of displaying the prediction letter display units.

13. A method of predicting and entering letters through a letter entry device, the method comprising the steps of:
displaying one or more pairs of prediction letter display units in each of which first and second indication locations are arranged around a reference location provided at a specific point of a display window and a classification word to classify words of a specific language is disposed in each of the indication locations;
in order to write a sentence composed of the language, selecting an indication location in which a classification word to which words of the sentence belong is displayed using the letter entry device in the prediction letter display unit;
reconfiguring or extending the prediction letter display unit on the basis of original forms of words belonging to the selected classification word;
selecting an indication location in which an original form of an intended word is displayed using the letter entry device in the prediction letter display unit;
pressing an enter key in order to finally select and enter the selected word;
if the enter key is not pressed in a state in which the word has been selected, determining that a modification of the selected word is required and reconfiguring the prediction letter display unit using a modified form name of the word;
selecting an indication location in which the modified form name of the word is displayed using the letter entry device in the prediction letter display unit; and
converting, entering, and processing the word in accordance the modified form name.

14. The method of claim 13, further comprising the step of pressing a specific execution key in the letter entry device in order to execute a prediction letter entry mode, before the step of displaying the prediction letter display units.

15. A method of predicting and entering letters through a letter entry device, the method comprising the steps of:
entering a specific word as a premise letter;
displaying one or more pairs of prediction letter display units in each of which first and second indication locations are arranged around a reference location provided at a specific point of a display window and a classification word to classify words of a specific language is disposed in each of the indication locations;
in order to write a sentence composed of the language, selecting an indication location in which a classification word to which words of the sentence belong is displayed using the letter entry device in the prediction letter display unit; and
selecting, entering, and processing a word which can be placed behind the premise letter, from among the words belonging to the classification word.

16. A method of predicting and entering letters through a letter entry device, the method comprising the steps of:
displaying one or more pairs of prediction letter display units in each of which first and second indication locations are arranged around a reference location provided at a specific point of a display window and a classification word to classify words of a specific language is disposed in each of the indication locations;
in order to write a sentence composed of the language, selecting an indication location in which a classification word to which words of the sentence belong is displayed using the letter entry device in the prediction letter display unit;
in order to automatically enter the words belonging to the classification word, selecting a classification word following the selected classification word in the prediction letter display unit;
reconfiguring or extending the prediction letter display unit using original forms of words belonging to the following classification word and modified words of the original forms;
selecting an indication location in which an original form of an intended word or a modified word of the original form is displayed using the letter entry device in the prediction letter display unit; and
entering and processing the original form of the selected word or the modified word of the original form, converting the preceding classification word into a proper word on the basis of the original form of the word or the modified word of the original form, and entering and processing the converted word.

17. The method of claim 16, further comprising the step of pressing a specific execution key in the letter entry device in order to execute a prediction letter entry mode, before the step of displaying the prediction letter display units.

18. A method of predicting and entering letters through a letter entry device, the method comprising the steps of:
entering a specific word as a premise letter;
displaying one or more pairs of prediction letter display units in each of which first and second indication locations are arranged around a reference location provided at a specific point of a display window and a classification word to classify words of a specific language is disposed in each of the indication locations;
in order to write a sentence composed of the language, selecting an indication location in which a classification word to which words of the sentence belong is displayed using the letter entry device in the prediction letter display unit;
selecting an indication location in which an intended word from among the words belonging to the classification word is displayed using the letter entry device; and
converting the intended word into a modified form of a word, complying with the premise letter, on the basis of the premise letter and entering and processing the converted word.

19. The method of claim 18, wherein in the display step, only a classification word to which words capable of being coupled to the premise letter belong is disposed.

20. A method of predicting and entering letters through a letter entry device, in which data corresponding to a contact point in a display window or contact movement for the contact point are received in response to a contact or contact movement for the display window and the received data are displayed in the display window, the method comprising the steps of:
arranging a plurality of primary locations around a reference location provided at a specific point of the display window and displaying a classification word to classify words of a specific language in each of the primary locations;
in order to write a sentence composed of the language, selecting a primary location in which a classification word to which the words of the sentence belong is displayed through a contact or contact movement;
displaying the words, belonging to the classification word, in secondary locations around the selected primary location;
selecting one of the words disposed in the secondary locations through a contact or contact movement;
displaying modified forms of words, corresponding to the selected word, in tertiary locations around the selected secondary location;
if the selected word is processed or modified forms of the selected word is required, selecting one of the modified forms of the words disposed in the tertiary locations through a contact or contact movement; and
modifying the word to the modified forms of the selected word and entering and processing the modified word.

21. The method of claim 20, wherein the selected secondary location becomes a reference location for the primary location around the selected secondary location and thus a classification word corresponding to the first reference location is distinguished from a modified form of a word corresponding to the tertiary location and then displayed.

22. The method of claim 21, wherein a word selected in the second or tertiary location or a modified form of the word becomes a premise letter so that the word or the modified form of the word is modified to comply with the premise letter and then entered and processed.

23. A method of predicting and entering letters through a letter entry device, in which data corresponding to a contact point in a display window or contact movement for the contact point are received in response to a contact or contact movement for the display window and the received data are displayed in the display window, the method comprising the steps of:
radially arranging a plurality of primary locations around a reference location provided at a specific point of the display window, displaying a classification word to classify words of a specific language in each of the primary locations, radially arranging a plurality of secondary locations around each of the primary locations, displaying words belonging to each of the classification words in each of the secondary locations, radially arranging a plurality of tertiary locations around each of the secondary locations, and displaying modified forms of each word in each of the tertiary locations;
in order to write a sentence composed of the language, selecting a primary location in which a classification word to which words of the sentence belong is displayed through a contact or contact movement;
selecting one of words, belonging to the classification word and disposed in the secondary locations, through a contact or contact movement;
selecting modified forms of the selected word, from among modified forms of words disposed in the tertiary locations, through a contact or contact movement; and
entering and processing the selected word or a modified form of the word.

24. The method of claim 23, wherein in the display step, the primary location corresponding to the classification word is enlarged and displayed, and the secondary locations and the tertiary locations are relatively reduced in size and displayed.

25. The method of claim 23, wherein in the step of selecting one of the words, a secondary location in which words are disposed around the selected classification word is enlarged and displayed, and the primary locations and the tertiary locations are relatively reduced in size and displayed.

26. The method of claim 23, wherein in the step of selecting the modified forms of the selected word, a tertiary location in which modified forms of a word are arranged around the selected word is enlarged and displayed, and the primary locations and the secondary locations are relatively reduced in size and displayed.

27. A method of predicting and entering letters through a letter entry device, in which data corresponding to a contact point in a display window or contact movement for the contact point are received in response to a contact or contact movement for the display window and the received data are displayed in the display window, the method comprising the steps of:
radially arranging a plurality of primary locations around a reference location provided at a specific point of the display window, displaying a classification word to classify words of a specific language in each of the primary locations, arranging a plurality of secondary locations around each of the primary locations, displaying words belonging to each of the classification words in each of the secondary locations, and arranging tertiary locations in which modified forms of words are displayed in a selection area separately from the first and secondary locations;
selecting one or more of the classification words displayed in the primary locations, the words displayed in the secondary locations, and the modified forms of the words displayed in the tertiary locations through a contact or contact movement; and
entering and processing the selected word or modified forms of the selected word.

28. The method of claim 27, wherein the selection step comprises the steps of:
in order to write a sentence composed of the language, selecting a primary location in which a classification word to which words of the sentence belong is displayed through a contact or contact movement;
selecting one of words, belonging to the classification word and disposed in the secondary locations, through a contact or contact movement; and
selecting one or more tertiary locations of the modified forms of the words displayed in the selection area for the selected word.

29. The method of claim 27, wherein the selection step comprises the steps of:
selecting one of the words disposed in the secondary locations through a contact or contact movement; and
selecting one or more tertiary locations of the modified forms of the words displayed in the selection area for the selected word.

30. The method of claim 27, wherein the selection step comprises the steps of:
selecting one or more tertiary locations of the modified forms of the words displayed in the selection area; and
selecting a word to be converted into the modified form, selected in the tertiary location, in the secondary location.

31. A letter entry device in which letters are entered using a method according to claim 11.
